(19) United States
(12) Patent Application Publication
(10) Pub. No.: US 2003/0187721 A1
(43) Pub. Date: Oct. 2, 2003

(54) Method and apparatus for rating information management

(76) Inventors: Fumiharu Etoh, Fukuoka (JP); Tsukasa Iwanaga, Fukuoka (JP); Koji Yoshioka, Fukuoka (JP); Yuji Hino, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/299,353

(22) Filed: Nov. 19, 2002

Related U.S. Application Data
(63) Continuation-in-part of application No. 10/113,764, filed on Apr. 1, 2002.

(30) Foreign Application Priority Data
Jul. 31, 2002 (JP) 2002-223457

(51) Int. Cl. G06F 17/60

(52) U.S. Cl. 705/10

(57) ABSTRACT

In a method and an apparatus for rating information management, a server registers rater information inputted by a rater from the access terminal, prepares rating identification information associated with a rated item to be assigned to a rated party, who is a provider of the rated item, through the access terminal when requested by when the rated party requests from the access terminal to assign a rating identification information which the rated party provides to the rater at a same time when the rated item is provided to the rater, confirms that the rater has been registered in the server and that the rating identification information is correct, and stores the rating information together with the rating identification information in a database when the rater inputs the rating identification information assigned to the rated item by the rated party with rating information added thereto from the access terminal.

This is a continuation-in-part application of U.S. patent application Ser. No. 10/113,764, filed on Apr. 1, 2002 now abandoned.

### BACKGROUND OF THE INVENTION

1. Field of the Invention

The present invention relates to a method and an apparatus for rating information management, and in particular to a method and an apparatus for managing rating (evaluation) information provided by raters (evaluators) through a communication network.

2. Description of the Related Art

Upon selecting and purchasing a product (including service) in the presence of numerous similar products, consuming public requires information for determining which of the products satisfies its desire most. Some of such information can be obtained from mass media such as newspapers, magazines, televisions, and radios, as well as from communities through advertisements, handouts, and word of mouth.

Also, in recent years, various services have been provided over a network with spread of communication services represented by the Internet, so that a variety of services enabling access to the above-mentioned information on the network are provided.

It has not been possible for the consuming public to acquire means enabling a nationwide, real-time, and bi-directional cost comparison of various products, product rating announcements, and information interchange. The fact that the consuming public has possessed media by the development of the network service so that transmission and interchange of information have been made possible may be called an improvement of social infrastructures.

Among services utilizing characteristics of the network, there is one called a rating site for providing product rating and comparison services. The object of the rating site is to compare prices of products or services (hereinafter, referred to as rated items) of different companies (providers), and to publicize ratings and opinions related to specifications and qualities of the rated items provided by the consuming public on the network, thereby providing information for other consuming public's use or purchase.

FIG. 49 shows an example of such a rating site. As shown, a server 100 operated by a service provider providing the rating site is connectable through a network NW from an arbitrary access terminal including an access terminal 300 of a general user (including a rater) accessing the rating site.

The server 100 has a database DB for storing various information, an input/output (I/O) portion 1 for inputting/outputting various information through the network NW, a rater information manager 2 for managing rater information registered in the database DB, a rating information controller 3 for controlling rating information inputted/outputted, a rating information editor 4 for editing the rating information to be displayed, and a rating information manager 5 for managing the rating information registered in the database DB.

For example, a processing in the server 100 when a general user requests a browsing the rating information provided to the rating site will be described referring to a sequence diagram of FIG. 50.

When the general user requests browsing the rating information, the I/O portion 1 in the server 100 firstly transmits rating information display request M1 to the rating information controller 3. The rating information controller 3 transmits a rating information request M2 to the rating information manager 5 in order to request the rating information for which the browsing has been requested.

The rating information manager 5 retrieves the requested rating information from the database DB to be transmitted to the rating information controller 3 as a rating information retrieval result M3. The rating information controller 3 transmits the received rating information retrieval result M3 as a rating information edit request M4 to the rating information editor 4 so as to be edited for a screen display.

The rating information editor 4 edits the received rating information for the screen display to be transmitted as rating information M5 to the I/O portion 1. The I/O portion 1 outputs the received rating information M5 as a display to the general user.

The above-mentioned rating site in status quo is not operated by a kind of an official entity such as a company or a municipality, but is operated personally or unofficially. Although the gravity is centered on a consuming public's standpoint, such a rating site remains as a site for exchanging anonymous personal opinions by arbitrary raters, so that it is difficult to say that reliability of the rating information thereof is socially acknowledged.

Also, it is difficult to say that credibility of the fact that the product or the service has been purchased or used is high. There is a tendency that information of a mere low cost is highly valued. When anonymous inadequate information is open to the public, there is a possibility that a company (provider) and a product (including service) are affected adversely, and when inadequate cost information is open to the public, a fair price of the product becomes difficult to maintain, so that there is a possibility that fair profits of the company are impaired.

In such a rating site, when the consuming public becomes a rater and publicizes a rating of a product or a service on the rating site, it is general that the rater does not disclose its personal information but uses a nickname only used on a network. Also, since it is possible to rate or evaluate a product or a service without an actual use thereof, it is even possible that a person with malevolence to the product or the company easily publicizes deceitful rating information.

On the other hand, it is the present situation that the company is only exposed to the one-sided rating without having means for opposing to or preventing the deceitful rating information. Also, by analyzing highly reliable rating information, the company is enabled to reflect an analysis result to the product or the service. However, a mechanism to feed back useful rating information to the company from the rating site has not been established in status quo.

Also, based on the highly reliable rating information, a mechanism for distributing information from the company to the rater that has inputted the rating information, and a mechanism for the company to collect response information from the rater to the distributed information would be beneficial to both of the rater and the company. However, such mechanisms have not been established.

As a method of improving reliability of rating information, U.S. Pat. No. 5,950,172 (hereinafter, referred to as Klingman patent) discloses a “Secured Electronic Rating System”.

Namely, in the Klingman patent, a server for managing product rating information checks a purchaser identifying number prepared at the time of a consumer's purchase of the product, and then provides the consumer with a form for filling in a rating score. The consumer provides the server with rating information using the form, thereby limiting one rating input for one purchaser in order to improve the accuracy of the product rating.

Thus, basically, a non-purchaser of the product can not perform a rating input, so that a mechanism is realized where reliability improvements to some degree can be anticipated.

However, the Klingman patent merely provides a mechanism for a consumer having purchased the product to rate the product, and the possibility that the consumer makes unreasonable rating is still high since the rating is anonymous.

Also, the Klingman patent does not provide information useful for a rated party (evaluated party) such as information for continuously investigating what kind of rating a particular consumer provides for other products, or information for comparison with similar products provided by other companies.

### SUMMARY OF THE INVENTION

It is accordingly an object of the present invention to provide a method and an apparatus for rating information management for managing and presenting rating information of a higher reliability.

Moreover, it is another object of the present invention to enable information to be distributed to raters based on highly reliable rating information and response information to be collected from the raters in response thereto.

In order to achieve the above-mentioned object, a rating information management method comprises: a first step, by a rater, of registering rater information in a server from an arbitrary access terminal connected to a network; a second step, by a rated party who is a provider of a rated item, of requesting the server from the access terminal to assign a rating identification information which the rated party provides to the rater at a same time when the rated item is provided to the rater; a third step, by the server, in response to the second step, of preparing the rating identification information associated with the rated item to be assigned to the rated party through the access terminal; a fourth step, by the rater, of inputting the rating identification information assigned to the rated item by the rated party with rating information added thereto to the server from the access terminal; a fifth step, by the server, of confirming that the rater has been registered in the server and that the rating identification information is correct, and storing the rating information together with the rating identification information in a database. (claim 1)

Hereinafter, a rating information management method according to the present invention will be described referring to an overall arrangement of FIG. 1 composed of a server 100, and access terminals 200 and 300 connected to a network NW.

Namely, at the first step, a rater “B” registers rater information on the server 100 from the access terminal 300.

Next, at the second step, a rated party “A” who is a provider of a rated item requests from the access terminal 200 to the server 100 an assignment of rating identification information which the rated party “A” provides to the rater “B” at the same time when the rated item is provided to the rater “B”.

At the third step, the server 100 in response to the second step, prepares the rating identification information associated with the rated item to be assigned to the rated party “A” through the access terminal 200.

On the other hand, at the fourth step, the rater “B” provided with the rated item adds rating information to the rating identification information assigned by the rated party “A” to the rated item from the access terminal 300 to be inputted to the server 100.

At the fifth step, the server 100 confirms that the rater “B” has been registered in the server 100 and that the rating identification information is correct, and stores the rating information in the database DB with the rating identification information inputted at the fourth step.

Thus, only the rater who has preliminarily registered the rater information inputs the rating information, so that it is made possible to deter input of unfair rating information due to anonymity. Also, the fact that the rater is actually provided with the rated item can be confirmed by the rating identification information, so that it is made possible to manage and present rating information of a higher reliability.

Also, the rating information management method according to the present invention may further comprise: a sixth step, by the rated party, of registering rated party information in the server from the access terminal prior to the second step; the server confirming that the rated party has been registered in the server before preparing the rating identification information at the third step. (claim 2)

Namely, at the sixth step, the rated party “A” preliminarily registers rated party information in the server 100 from the access terminal 200. In this case, at the above-mentioned third step, the server prepares the rating identification information after confirming that the rated party “A” has been already registered in the server 100.

Thus, all but the rated party having preliminarily registered the rated party information can not receive the assignment of the rating identification information, so that the reliability of the rating information can be further improved.

Also, the rating information management method according to the present invention may further comprise: a seventh step, by an arbitrary general user, of requesting the server from the access terminal to present the rating information; and an eighth step, by the server in response to the seventh step, of presenting the rating information to the access terminal. (claim 3)

Namely, at the seventh step, an arbitrary general user including the rated party “A” and the rater “B” requests the server 100 to present the rating information from e.g. the access terminal 200. At the eighth step, the server 100 presents the rating information to the access terminal 200.

Also, the rating information management method according to the present invention wherein the rating identification information includes common identification information common to a plurality of rated parties may further comprise: a ninth step, by a requester preliminarily registered in the server, of requesting the server from the access terminal to analyze the rating information based on the common identification information; and a tenth step, by the server in response to the ninth step, of confirming that the requester has been registered, and thereafter notifying a result of an analysis of the rating information based on the common identification information to the requestor through the access terminal. (claim 4)

Namely, when the rating identification information includes common identification information common to a plurality of rated parties including the above-mentioned rated party “A”, at the ninth step, e.g. the rated party “A” as a requester preliminarily registered in the server 100 requests the server 100 from the access terminal 200 to analyze the rated information based on the common identification information.

In response thereto at the tenth step, the server 100 confirms that the rated party “A”, that is the requester, has been already registered, and then notifies a result of an analysis of the rating information based on the common identification information to the rated party “A” through the access terminal 200.

Thus, it is made possible to analyze the rating information using the common identification information common to a plurality of rated parties, so that a useful analysis result may be obtained by the requester.

In this case, the rating identification information may include individual identification information uniquely set by an individual rated party, and the rating information management method may further comprise: an eleventh step, by the requester, of requesting the server from the access terminal to analyze the rating information based on the individual identification information; and a twelfth step, by the server in response to the eleventh step, of confirming that the requester has been registered, and thereafter notifying a result of an analysis of the rating information based on the individual identification information to the requester through the access terminal. (claim 5)

Namely, when the rating identification information includes individual identification information which is uniquely set by e.g. the rated party “A”, at the eleventh step, the requester (e.g. rated party “A”) requests the server 100 from access terminal 200 to analyze the rating information based on the individual identification information.

In response thereto at the twelfth step, the server 100 confirms that the rated party “A” has been registered, and then notifies a result of an analysis of the rating information based on the individual identification information to the rated party “A” through the access terminal 200.

Thus, it is made possible to analyze the rating information using the individual identification information which is unique to the requester, so that a more useful analysis result may be obtained.

Also, the rating information management method according the present invention may further comprise: a thirteenth step, by the server, of providing predetermined points to the rater who inputs the rating information. (claim 6)

Namely, at the thirteenth step, upon detecting that the rater “B” has inputted the rating information, the server 100 provides predetermined points to the rater “B” as incentives.

Thus, it is made possible to motivate the rater to rate reasonably and to continue rating. Also, since an increase of high-quality raters can be expected, it is made possible to improve the quality of rating information.

Also, the rating information management method according to the present invention wherein the rating identification information includes common identification information common to a plurality of rated parties may further comprise: a fourteenth step, by an arbitrary general user, of requesting the server from the access terminal to analyze the rating information based on the common identification information; and a fifteenth step, by the server in response to the fourteenth step, of notifying a result of an analysis of the rating information based on the common identification information to the general user through the access terminal. (claim 7)

Namely, when the rating identification information includes common identification information common to a plurality of rated parties including the above-mentioned rated party “A”, at the fourteenth step, an arbitrary general user requests the server 100 from e.g. the access terminal 300 to analyze the rated information based on the common identification information.

In response thereto at the fifteenth step, the server 100 notifies a result of an analysis of the rating information based on the common identification information to the general user through the access terminal 300.

Thus, it is made possible to analyze the rating information using the common identification information common to a plurality of rated parties, so that a useful analysis result may be obtained by the arbitrary general user.

In this case, the rating identification information may include individual identification information uniquely set by an individual rated party, and the rating information management method may further comprise: a sixteenth step, by the general user, of requesting the server from the access terminal to analyze the rating information based on the individual identification information; and a seventeenth step, by the server in response to the sixteenth step, of notifying a result of an analysis of the rating information based on the individual identification information to the general user through the access terminal. (claim 8)

Namely, when the rating identification information includes individual identification information which is uniquely set by e.g. the rated party “A”, at the sixteenth step, an arbitrary general user requests the server 100 from the access terminal 300 to analyze the rating information based on the individual identification information.

In response thereto at the seventeenth step, the server 100 notifies a result of an analysis of the rating information based on the individual identification information to the user through the access terminal 300.

Thus, it is made possible to analyze the rating information using the individual identification information unique to the rated party, so that a more useful analysis result may be obtained by the arbitrary general user.

It is to be noted that in the rating information management method according to the present invention, the rated item may include a service provided by the rated party. (claim 9)

Also, the rating information management method according to the present invention may further comprise: an eighteenth step, by a requestor preliminarily registered in the server, of designating an arbitrary extracting condition for the rating information and the rater information, and requesting the server from the access terminal to extract a specific rater corresponding to the extracting condition from among the raters; and a nineteenth step, by the server in response to the eighteenth step, of confirming that the requester has been registered, and thereafter extracting the specific rater. (claim 10)

Namely, at the eighteenth step, a requestor preliminarily registered in the server (e.g. rated party “A”) requests the server 100 from the access terminal 200 to extract a specific rater corresponding to the extracting condition from among the raters that have provided the rating information.

In response thereto at the nineteenth step, the server 100 confirms that the rated party “A”, that is the requestor, has been already registered, and then extracts the specific rater.

Thus, it is made possible to extract the specific rater by efficiently reusing the highly reliable rating information and the rater information accumulated in the server 100.

In this case, the rating information management method according to the present invention may further comprise: a twentieth step, by the requester, of designating arbitrary distributing information, and requesting the server from the access terminal to distribute the distributing information to the specific rater; and a twenty-first step, by the server in response to the twentieth step, of distributing the distributing information to the specific rater through the access terminal. (claim 11)

Namely, at the twentieth step after executing the above-mentioned nineteenth step, the requestor (e.g. rated party “A”) that requests the extraction of the specific rater transmits arbitrary distributing information to the server 100, and requests the server 100 from the access terminal 200 to distribute the distributing information to the specific rater (e.g. rater “B”) having already been extracted at the nineteenth step by the server.

In response thereto at the twenty-first step, the server 100 distributes the distributing information to the specific rater.

Therefore, since the rating information and the rater information accumulated in the server 100 are highly reliable, it is made possible for the requestor to distribute the distributing information corresponding to the rating information to the specific rater through the server 100.

Also, the rating information management method according to the present invention may include a step, by the requester, of designating a result notifying condition together with the distributing information in the above-mentioned twentieth step, and may further comprise: a twenty-second step, by the specific rater, of inputting response information for the distributing information from the access terminal to the server; and a twenty-third step, by the server in response to the twenty-second step, of accumulating the response information, and thereafter upon the result notifying condition being fulfilled, of notifying the accumulated response information to the requestor through the access terminal. (claim 12)

Namely, information inviting a response may be included in the distributing information transmitted to the server by the requestor at the above-mentioned twentieth step. In this case, in order to designate conditions such as timing for the server to notify the requester of the response information from the specific rater invited to respond, the requestor designates a result notifying condition together with the distributing information.

At the twenty-second step, the specific rater (e.g. rater “B”) inputs the response information for the distributing information from the access terminal 300 to the server 100.

In response thereto at the twenty-third step, the server 100 accumulates the response information, and thereafter notifies the requestor (rated party “A”) of the accumulated response information through the access terminal 200 when the result notifying condition designated by the requestor is satisfied.

Since the distributing information is distributed to the specific rater that is an appropriate target of the distribution, the probability of the specific rater to input the response information to the server becomes high, so that it is made possible to obtain the response information desired by the requester more reliably.

It is to be noted that the rating information management method according to the present invention may further comprise a twenty-fourth step, by a third party, when the requestor comprises the third party corresponding to neither the rated party nor the rater, of registering third party information to the server from the access terminal. (claim 13)

Namely, the above-mentioned requester, if only preliminarily registered in the server, may be a third party corresponding to neither the rated party nor the rater. In this case, the third party registers third party information in the server 100 from the access terminal 300 at the twenty-third step.

Also, in order to achieve the above-mentioned object, a rating information management apparatus comprises: an arbitrary access terminal connected to a network; and a server including first means for registering rater information inputted by a rater from the access terminal, second means for preparing rating identification information associated with a rated item to be assigned to a rated party, who is a provider of the rated item, through the access terminal when requested by the rated party from the access terminal to assign a rating identification information which the rated party provides to the rater at a same time when the rated item is provided to the rater, and third means for confirming that the rater has been registered in the server and that the rating identification information is correct, and storing the rating information together with the rating identification information in a database when the rater inputs the rating identification information assigned to the rated item by the rated party with rating information added thereto from the access terminal. (claim 14)

Namely, the rating information management apparatus according to the present invention is provided with the arbitrary access terminals 200 and 300 connected to the network NW as shown by the overall arrangement of FIG. 1.

The server 100, as in the prior art shown in FIG. 35, has a database DB for storing various information, an I/O portion 1 for inputting/outputting various information through the network NW, a rater information manager 2 for managing rater information registered in the database DB, a rating information controller 3 for controlling rating information inputted/outputted, a rating information editor 4 for editing the rating information to be displayed, and a rating information manager 5 for managing the rating information registered in the database DB.

Also, in addition to those mentioned above, the server 100 is provided with a rating identification information distributor 6 for distributing rating identification information, a rating identification information manager for managing the rating identification information registered in the database DB, an authenticator 8 for performing various authentications, a rated party information manager 9 for managing rated party information registered in the database DB, and a rating information analyzer 10 for analyzing the rating information.

It is to be noted that in FIG. 1, the database DB is shown as if it is independent of other components in the server 100. However, as a matter of fact, the database DB is connected to the rater information manager 2, the rating information manager 5, the rating identification information manager 7, and the rated party information manager 7.

Hereinafter, means that the server 100 has will be described.

Firstly, by the first means, the I/O portion 1 receives the rater information inputted from the access terminal 300 by e.g. the rater “B”, and the rater information manager 2 registers same in the database DB.

Also, by the second means, when e.g. the rated party “A” who is the provider of the rated item request from the access terminal 200 an assignment of rating identification information which the rated party “A” provides to the rater “B” at the same time the rated item is provided to the rater “B”, the I/O portion 1 receives the request, the rating identification information manager 7 prepares the rating identification information associated with the rated items to be outputted from the I/O portion 1 through the information identifying information distributor 6, and eventually assigned to the rated party “A” through the access terminal 200.

Also, by the third means, when e.g. the rater “B” inputs the rating identification information assigned to the rated item by the rated party with rating information added thereto from the access terminal 300, the I/O portion 1 receives the rating information inputted together with the rating identification information, the authenticator 8 and the rater information manager 2 cooperatively confirm that the rater has been registered, the authenticator 8 and the rating identification information manager 7 cooperatively confirm that the rating identification information is correct, the rating information controller 3 and the rating information manager 5 cooperatively store the rating information together with the rating identification information in the database DB.

Also, in the rating information management apparatus according to the present invention the server may further include fourth means for registering rated party information inputted by the rated party from the access terminal, and the second means may include means for confirming that the rated party has been registered before preparing the rating identification information. (claim 15)

Namely, by the fourth means included in the server 100, the I/O portion 1 receives the rated party information inputted by the rated party “A” from the access terminal 200 and the rated party information manager 9 registers the same in the database DB. In this case, as the means included in the second means, the authenticator 8 and the rated party information manager 9 cooperatively confirm that the rated party “A” has been registered in the server 100 before generating the rating identification information.

Also, in the rating information management apparatus according to the present invention, the server may further include fifth means for presenting the rating information to the access terminal when requested by an arbitrary general user from the access terminal to present the rating information. (claim 16)

Namely, by the fifth means included in the server 100, when an arbitrary general user requests the server 100 from e.g. the access terminal 200 to present the rating information, the I/O portion 1 receives the request, the rating information controller 3 and the rating information manager 5 cooperatively extract the rating information from the database DB to be outputted to the I/O portion 1 through the rating information editor 4.

Also, in the rating information management apparatus according to the present invention, the rating identification information may include common identification information common to a plurality of rated parties, and the server may further include sixth means confirming that a requestor preliminarily registered in the server has been registered, and thereafter notifying a result of an analysis of the rating information based on the common identification information to the requester through the access terminal when requested by the requestor from the access terminal to analyze the rating information based on the common identification information. (claim 17)

Namely, when the rating identification information includes common identification information common to a plurality of rated parties including the above-mentioned rated party “A”, as the sixth means further included in the server 100, when e.g. the rated party “A” as a requestor preliminarily registered in the server 100 requests from the access terminal 200 to analyze the rating information based on the common identification information, the I/O portion 1 receives this request, the authenticator 8 and the rated party information manager 9 cooperatively confirm that the rated party “A”, that is the requestor, has been registered, and the rating information analyzer 10 outputs a result of an analysis of the rating information based on the common identification information from the I/O portion 1 through the rating information editor 4 to be notified to the rated party “A” through the access terminal 200.

In this case, the rating identification information may include individual identification information uniquely set by an individual rated party, and the server may further include seventh means for confirming that the requester has been registered, and thereafter notifying a result of an analysis of the rating information based on the individual identification information to the requester through the access terminal when requested by the requestor from the access terminal to analyze the rating information based on the individual identification information. (claim 18)

Namely, when the rating identification information includes common identification information common to a plurality of rated parties including the above-mentioned rated party “A”, by the seventh means further included in the server 100, when the requester (e.g. rated party “A”) requests from the access terminal 200 to analyze the rating information based on the individual identification information, the I/O portion 1 receives this request, the authenticator 8 and the rated party information manager 9 cooperatively confirm that the rated party “A” has been registered, and the rating information analyzer 10 outputs a result of an analysis of the rating information based on the individual identification information from the I/O portion 1 through the rating information editor 4 to be notified to the rated party “A” through the access terminal 200.

Also, in the rating information management apparatus according to the present invention, the server may further include eighth means for providing predetermined points to the rater who inputs the rating information. (claim 19)

Namely, by the eighth means included in the server 100, e.g. when the rating information controller 3 detects that the rater “B” inputted the rating information, the rater information manager 2 provides the rater “B” predetermined points based on the request from the rating information controller 3.

Also, in the rating information management apparatus according to the present invention, the rating identification information may include common identification information common to a plurality of rated parties, and the server may further include ninth means for notifying a result of an analysis of the rating information based on the common identification information to the general user through the access terminal when requested by an arbitrary general user from the access terminal to analyze the rating information based on the common identification information. (claim 20)

Namely, when the rating identification information includes common identification information common to a plurality of rated parties including the above-mentioned rated party “A”, by the ninth means further included in the server 100, when e.g. an arbitrary general user requests from the access terminal 200 to analyze the rating information based on the common identification information, the I/O portion 1 receives this request, and the rating information analyzer 10 outputs a result of an analysis of the rating information based on the common identification information from the I/O portion 1 through the rating information editor 4 to be notified to the general user through the access terminal 200.

In this case, the rating identification information may include individual identification information uniquely set by an individual rated party, and the server may further include tenth means for notifying a result of an analysis of the rating information based on the individual identification information to the general user through the access terminal when requested by the general user from the access terminal to analyze the rating information based on the individual identification information. (claim 21)

Namely, when the rating identification information includes individual identification information common to a plurality of rated parties including the above-mentioned rated party “A”, by the tenth means further included in the server 100, when e.g. an arbitrary general user requests from the access terminal 200 to analyze the rating information based on the individual identification information, the I/O portion 1 receives this request, and the rating information analyzer 10 outputs a result of an analysis of the rating information based on the individual identification information from the I/O portion 1 through the rating information editor 4 to be notified to the general user through the access terminal 200.

It is to be noted that in the rating information management apparatus according to the present invention, the rated item may include a service provided by the rated party. (claim 22).

Also, in the rating information management apparatus according to the present invention, the server may further include: eleventh means for confirming, when a requestor preliminarily registered in the server designates an arbitrary extracting condition for the rating information and the rater information and requests the server from the access terminal to extract a specific rater corresponding to the extracting condition from among the raters, that the requester has been already registered, and thereafter extracting the specific rater. (claim 23)

Namely, by the eleventh means included in the server 100, when a requester preliminarily registered in the server (e.g. rated party “A”) requests from the access terminal 200 to extract a specific rater corresponding to an arbitrary extracting condition from among the raters that have provided the rating information, the I/O portion 1 receives this request, the authenticator 8 and the rated party information manager 9 cooperatively confirm that the rated party “A” has been registered, and then the specific rater extractor 11, the information analyzer 10, and the rating information manager 5 mutually cooperate and further extract the specific rater corresponding to the extracting condition from the rating information manager 2.

In this case, the server may further include twelfth means for distributing, when the requester designates arbitrary distributing information and requests the server from the access terminal to distribute the distributing information to the specific rater, the distributing information to the specific rater through the access terminal. (claim 24)

Namely, when the requestor (e.g. rated party “A”) transmits arbitrary distributing information to the server 100, and requests that the distributing information is distributed to the specific rater (e.g. rater “B”) having already been extracted by the specific rater extractor 11 from the access terminal 200, by the twelfth means included in the server 100, the I/O portion 1 receives this request, and an information provider 12 distributes the distributing information to the specific rater extracted by the specific rater extractor 11.

Also, the server may further include thirteenth means for authenticating the specific rater when the specific rater inputs response information for the distributing information from the access terminal to the server, and thereafter accumulating the response information and notifying the requester of the accumulated response information through the access terminal upon the result notifying condition being fulfilled. (claim 25)

Namely, in the case where the requester (e.g. rated party “A”) has designated a result notifying condition together with the distributing information, by the thirteenth means included in the server 100, when the specific rater (e.g. rater “B”) inputs the response information for the distributing information from the access terminal 300, the I/O portion 1 receives the inputted response information, the authenticator 8 and the rater information manager 2 cooperatively authenticate the specific rater, an information collector 13 accumulates the inputted response information. When the result notifying condition is fulfilled, the information collector 13 and the rated party information manager 9 cooperatively notify the accumulated response information to e.g. the rated party “A” through the access terminal 200.

Also, the server may further include fourteenth means for registering, when the above-mentioned requester is a third party corresponding to neither the rated party nor the rater, in the server third party information inputted by the third party from the access terminal. (claim 26)

Namely, when the requester is a third party corresponding to neither the rated party nor the rater, by the fourteenth means included in the server, e.g. the I/O portion 1 receives third party information inputted by a third party “C” that is neither the rated party “A” nor the rater “B” from the access terminal 200 and the third party information manager 14 registers the third party information in the database DB.

### BRIEF DESCRIPTION OF THE DRAWINGS

The above and other objects and advantages of the invention will be apparent upon consideration of the following detailed description, taken in conjunction with the accompanying drawings, in which the reference numbers refer to like parts throughout and in which:

FIG. 1 is a block diagram showing an overall arrangement of the present invention;

FIG. 2 is a network diagram showing a schematic system of embodiments (1)-(7) of the present invention;

FIG. 3 is a flow chart showing a processing flow of a rater registration in an embodiment (1) of the present invention;

FIG. 4 is a screen layout diagram showing a rater registration screen in an embodiment (1) of the present invention;

FIG. 5 is a diagram showing an example of a rater authentication file in an embodiment (1) of the present invention;

FIG. 6 is a block diagram illustrating an operation of a server 100 upon a rater registration;

FIG. 7 is a diagram showing a format example of rating identification information in an embodiment (1) of the present invention;

FIGS. 8A and 8B are diagrams showing an individual setting example of individual identification information in an embodiment (1) of the present invention;

FIG. 9 is a diagram showing an example of a rated party authentication file in an embodiment (1) of the present invention;

FIG. 10 is a diagram showing an example of a company code determination file in an embodiment (1) of the present invention;

FIG. 11 is a diagram showing an example of a product/service code determination file in an embodiment (1) of the present invention;

FIG. 12 is is a diagram showing an example of a product/service detail code determination file (PC-related) in an embodiment (1) of the present invention;

FIG. 13 is a flow chart showing a processing flow (without individual identification information setting) of a rating identification information assignment in an embodiment (1) of the present invention;

FIG. 14 is a screen layout diagram showing an input screen for a rating identification information assignment request in an embodiment (1) of the present invention;

FIG. 15 is a diagram showing a rating identification information management file in an embodiment (1) of the present invention;

FIG. 16 is a flow chart showing a processing flow (with individual identification information setting) of a rating identification information assignment in an embodiment (1) of the present invention;

FIG. 17 is a block diagram illustrating an operation of a server 100 upon a rating identification information assignment;

FIG. 18 is a sequence diagram showing an operation sequence of portions in FIG. 17;

FIG. 19 is a flow chart showing a processing flow of a rating information registration in an embodiment (1) of the present invention;

FIG. 20 is a screen layout diagram showing a notebook PC rating information input screen in an embodiment (1) of the present invention;

FIG. 21 is a diagram showing a notebook PC-related rating information file in an embodiment (1) of the present invention;

FIG. 22 is a block diagram illustrating an operation of a server 100 at steps S31-S36 of FIG. 19;

FIG. 23 is a sequence diagram showing an operation sequence of portions in FIG. 22;

FIG. 24 is a block diagram illustrating an operation of a server 100 at steps S37-S40 of FIG. 19;

FIG. 25 is a sequence diagram showing an operation sequence of portions in FIG. 24;

FIG. 26 is a flow chart showing a processing flow of an embodiment (2) of the present invention;

FIG. 27 is a block diagram illustrating an operation of a server 100 in the processing flow of FIG. 26;

FIG. 28 is a flow chart showing a processing flow of an embodiment (3) of the present invention;

FIG. 29 is a block diagram illustrating an operation of a server 100 in the processing flow of FIG. 28;

FIG. 30 is a sequence diagram showing an operation sequence of portions in FIG. 29;

FIGS. 31A and 31B are diagrams showing a company-by-company notebook PC comparison result in an embodiment (3) of the present invention;

FIG. 32 is a flow chart showing a processing flow of an embodiment (4) of the present invention;

FIGS. 33A-33C are diagrams showing a notebook PC analysis result according to individual information of a company A in an embodiment (4) of the present invention;

FIG. 34 is a sequence diagram showing an operation sequence of portions of a server 100 in an embodiment (5) of the present invention;

FIG. 35 is a diagram showing an example of a rater authentication file in an embodiment (7) of the present invention;

FIG. 36 is a diagram showing an example of a company code determination file in an embodiment (7) of the present invention;

FIG. 37 is a diagram showing a notebook PC-related rating information file in an embodiment (7) of the present invention;

FIG. 38 is a screen layout diagram showing a specific rater extracting condition input screen in an embodiment (7) of the present invention;

FIG. 39 is a block diagram illustrating an operation of a server 100 upon a rater extraction;

FIG. 40 is a sequence diagram showing an operation sequence of each portion in FIG. 39;

FIG. 41 is a diagram showing an example of distributing information in an embodiment (7) of the present invention;

FIG. 42 is a diagram showing an example of a distributing document file in an embodiment (7) of the present invention;

FIG. 43 is a block diagram illustrating an operation of a server 100 upon a distribution of distributing information and a reception of response information;

FIG. 44 is a sequence diagram showing an operation sequence (1) of portions in FIG. 43;

FIG. 45 is a diagram showing a format example of a distributing document code in an embodiment (7) of the present invention;

FIG. 46 is a screen layout diagram showing a response information input screen in an embodiment (7) of the present invention;

FIG. 47 is a sequence diagram showing an operation sequence (2) of portions in FIG. 43;

FIG. 48 is a diagram showing an example of a response data file for questionnaire on notebook PC replacement purchase plans in an embodiment (7) of the present invention;

FIG. 49 is a block diagram showing an overall arrangement of a prior art; and

FIG. 50 is a sequence diagram showing a rating information browsing sequence in a prior art.

### DESCRIPTION OF THE EMBODIMENTS

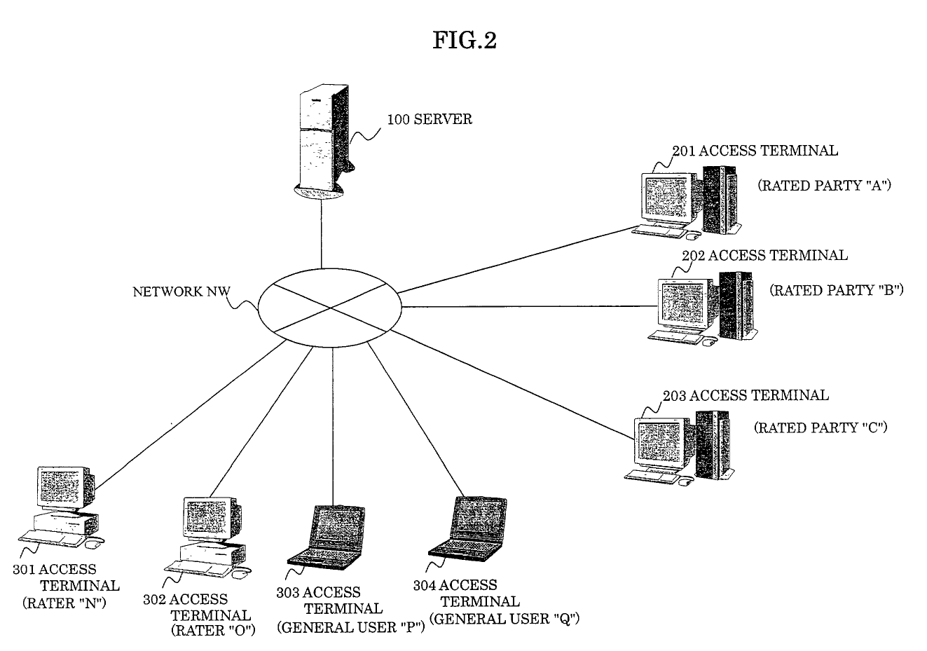

FIG. 2 is a schematic system diagram showing an embodiment of the present invention. As shown, a server 100, access terminals 201-203 of companies “A”, “B”, and “C” that are rated parties, and access terminals 301-304 of raters are connected to a network NW. It is to be noted that, the access terminals 301-304 in FIG. 2 include not only the terminals owned by raters “N” and “O” who actually input rating information but also terminals of general users “P” and “Q” who browse the rating information managed by the server 100.

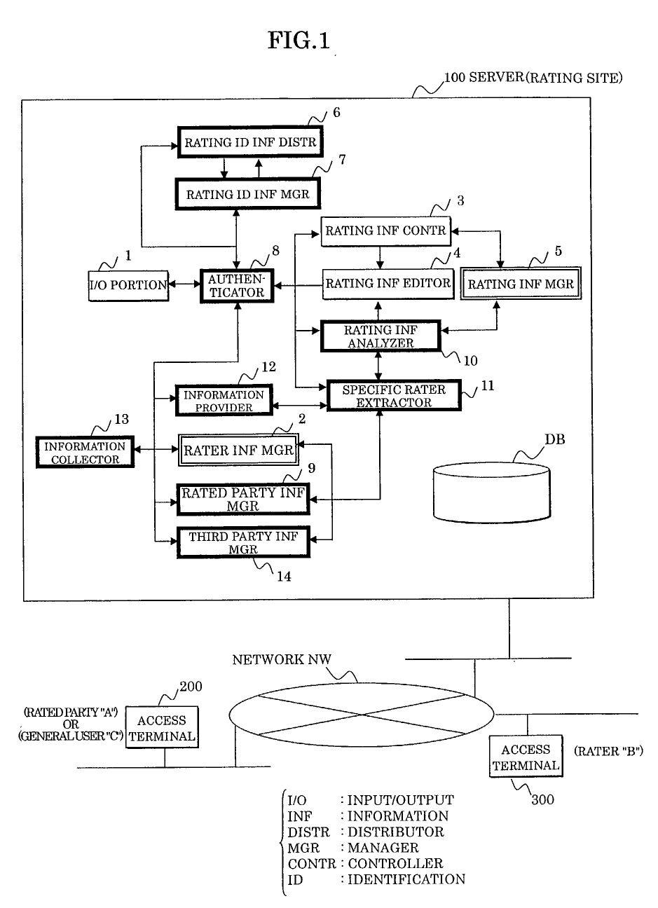

Also, the server 100 has the same arrangement as that shown in FIG. 1.

Embodiment (1)

Firstly, as an embodiment (1), (1-1) Rater registration, (1-2) Rating identification assignment to a rated party, and (1-3) Registration of rating information inputted by a rater will be described.

It is to be noted that the following description will be centered on arrangements and operations within the server 100. As for arrangements and operations of the access terminals, they can be realized by functions of access terminals of a general network, so that a detailed description thereof is omitted.

(1-1) Rater registration

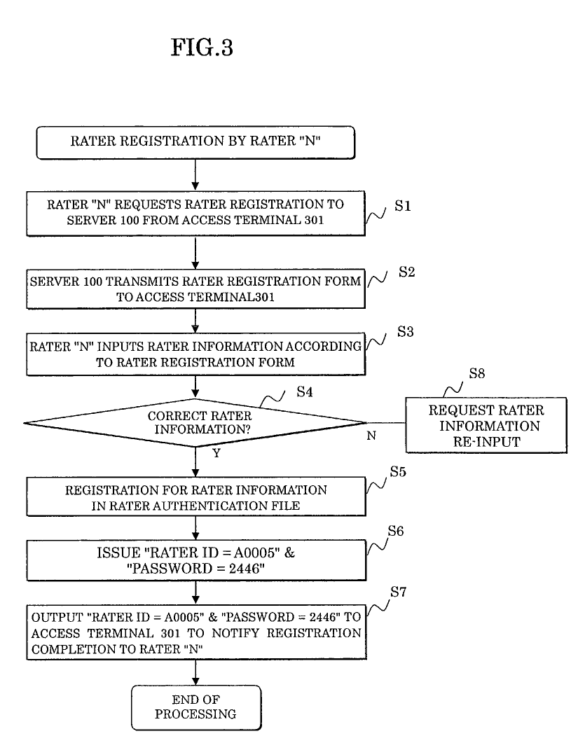

FIG. 3 shows an example of a processing flow of a rater registration performed by the rater “N” in the server 100.

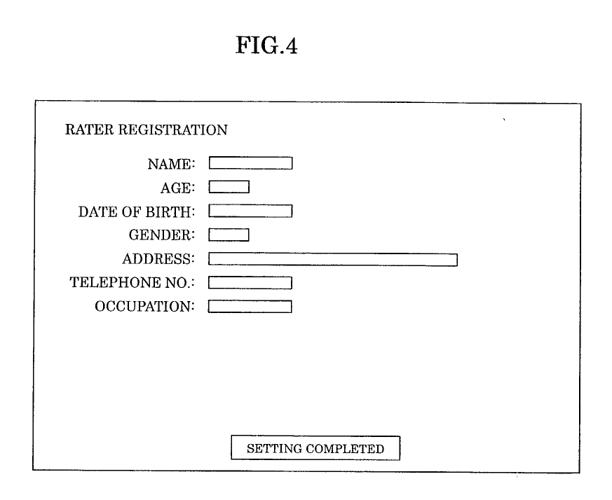

Firstly, the rater “N” requests a rater registration to the server 100 from e.g. the access terminal 301 of FIG. 2 (at step S1). The server 100 having received the rater registration request transmits a rater registration form to the access terminal 301 in order to display a rater registration screen as shown in FIG. 4 on a screen of the access terminal 301 (at step S2).

The rater “N” inputs required rater information such as a registration name, an age, a date of birth, a gender, an address, a phone number, and an occupation according to the form of the rater registration screen displayed on the screen of the access terminal 301 (at step S3).

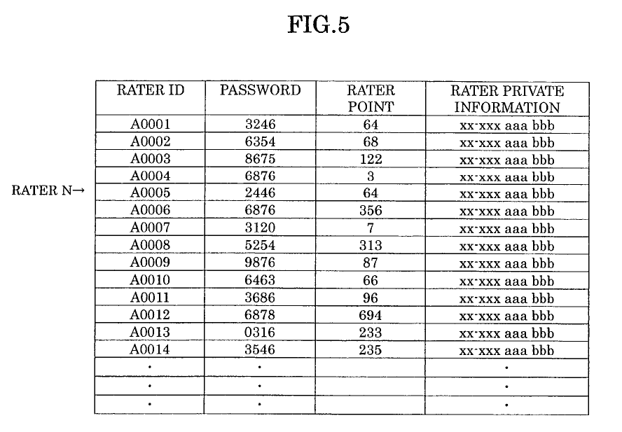

The server 100 confirms whether or not the rater information is correctly inputted (at step S4). Only when the rater information is not correctly inputted, the server 100 requests the rater information re-input to the rater “N” (at step S8). When the rater information is correctly inputted, the server 100 registers the inputted rater information in a rater authentication data file as shown in FIG. 5 (at step S5), and issues a rater ID and a password (at step S6) to be notified to the rater “N” through the access terminal 301 (at step S7).

In the example of FIG. 3, “rater ID=A0005” and “password=2446” are issued for the rater “N”.

It is to be noted that in the example of the rater authentication data file shown in FIG. 5, in addition to the rater ID, the password, and the inputted rater information, items of a rater point are shown, which will be described later in an embodiment (6).

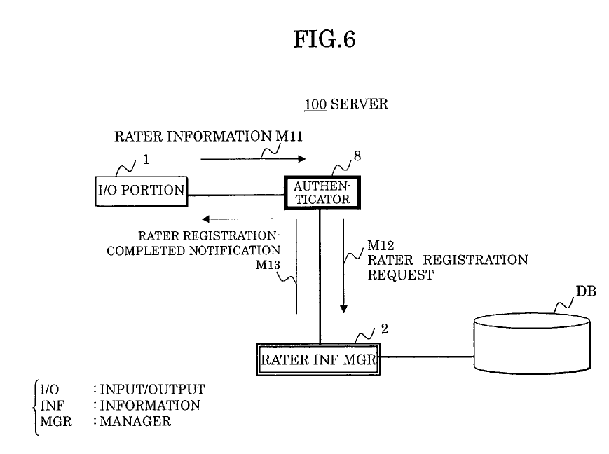

Operations of the portions in the server 100 when the server 100 registers the rater information according to the above-mentioned processing flow will be described referring to FIG. 6. It is to be noted that FIG. 6 shows only the components related to the rater information registration extracted from among the components of the server 100 shown in FIG. 1.

The rater information inputted by the rater “N” at the above-mentioned step S3 is received by the I/O portion 1 of the server 100. The I/O portion 1 transmits received rater information M11 to the authenticator 8. After confirming the rating information M11 as described at the above-mentioned step S4, the authenticator 8 transmits a rater registration request M12 to the rater information manager 2.

The rater information manager 2 stores the rater information in the rater authentication file (see FIG. 5) in the database DB, and issues “rater ID=A0005” and “password-2446”, and then transmits a rater information registration-completed notification M13 to the I/O portion 1 through the authenticator 8.

The I/O portion 1 notifies the completion of the rater information registration to the rater “N” through the access terminal 301.

(1-2) Assignment of rating identification information to rated party

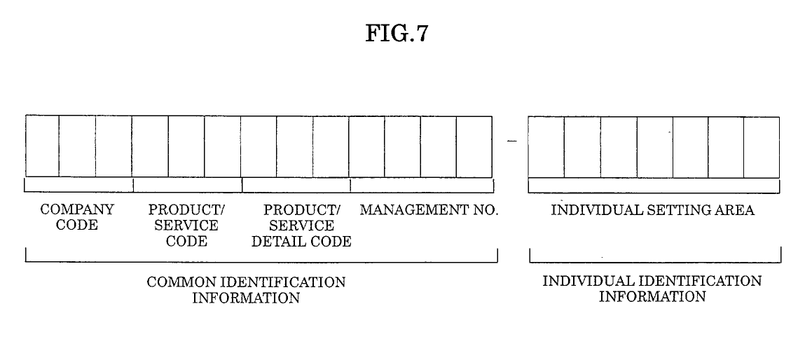

Firstly, the rating identification information assigned by the server 100 to the rated party in this embodiment will be described. FIG. 7 shows a format example of the rating identification information. As shown, the rating identification information in the embodiment (1) assumes a 20-digit numeral formed of 13-digit common identification information and 7-digit individual identification information.

The common identification information is common to a plurality of rated parties and formed of from the upper digits, a 3-digit “company code”, a 3-digit “product/service code”, a 3-digit “product/service detail code”, and a 4-digit “management No.”.

The remaining seven digits are individual setting area where a rated party can uniquely perform individual setting as individual identification information.

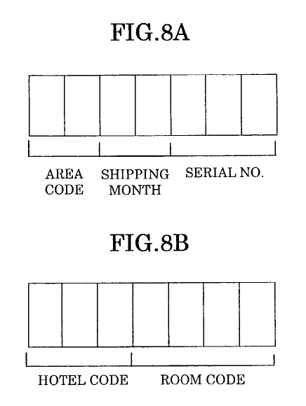

FIG. 8A shows an individual setting example of the individual identification information related to “product” in the individual setting area, where the first two digits assume an “area code”, the next two digits assume a “shipping month”, and the remaining three digits assume a “serial No.”.

FIG. 8B shows a setting example related to “service” in the individual setting area of the individual identification information shown in FIG. 7, supposing a hotel service, so that the first three digits assume a “hotel code” and the following four digits assume a “room code”.

Upon requesting the assignment of the rating identification information to the server 100, the rated party can designate a required number of rating identification information, thereby receiving the assignment of rating identification information excluding the individual identification information. Also, by designating the individual setting information of the individual identification information, the rated party can receive the assignment of the rating identification information including the individual identification information.

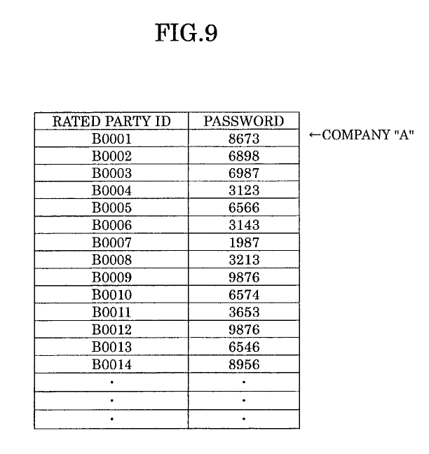

It is to be noted that as a precondition of the embodiment (1), the rated party is assumed to be preliminarily registered in the server 100. Therefore, in the database DB of the server 100, the rated party authentication file associating a rated party ID with a password as shown in FIG. 9 is already saved for the preliminarily registered rated party.

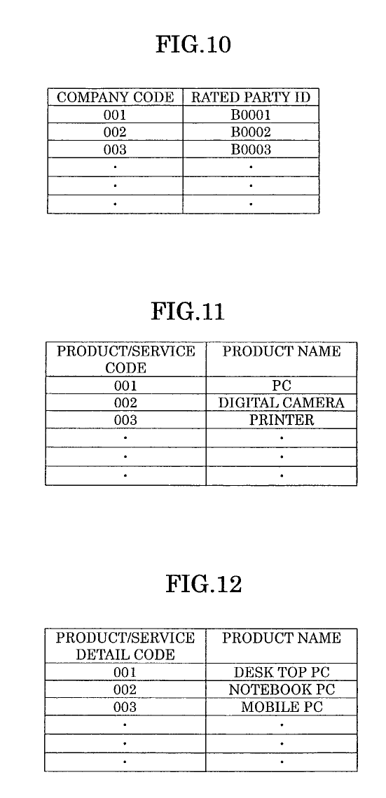

Also, it is assumed that a company code determination file, a product/service code determination file, and a product/service detail code determination file as shown respectively in FIGS. 10-12 to be referred when preparing the common identification information are preliminarily registered in the database DB, which respectively associate a company code with a rated party ID, a product/service code with a product/service name, and a product/service detail code with a product/service name.

Hereinafter, processing flows when a company “A” that is a rated party (hereinafter, referred to as rated party “A”) requests an assignment of the rating identification information to the server 100 from the access terminal 201 (see FIG. 2) respectively for the cases with and without individual identification information setting.

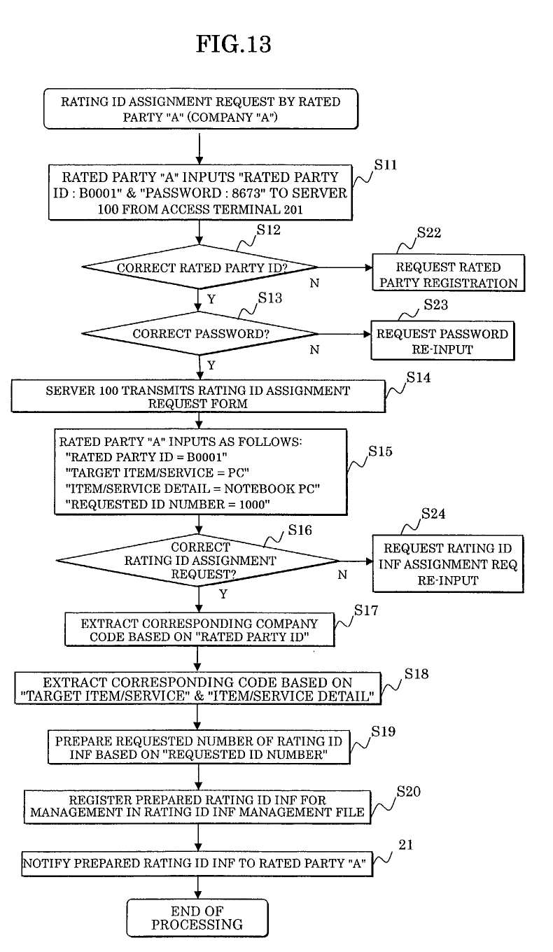

FIG. 13 shows a processing flow of a rating identification information assignment of the case without the individual identification information setting.

Firstly, the rated party “A” inputs “rated party ID=B0001” and “password=8673” to the server 100 (at step S11). The server 100 confirms whether or not the rated party ID is correct (at step S12), and further confirms whether or not the password is correct (at step S13). When the rated party ID is incorrect, the server 100 requests a rated party registration (at step S22). Otherwise, the server 100 requests a password re-input (at step S23).

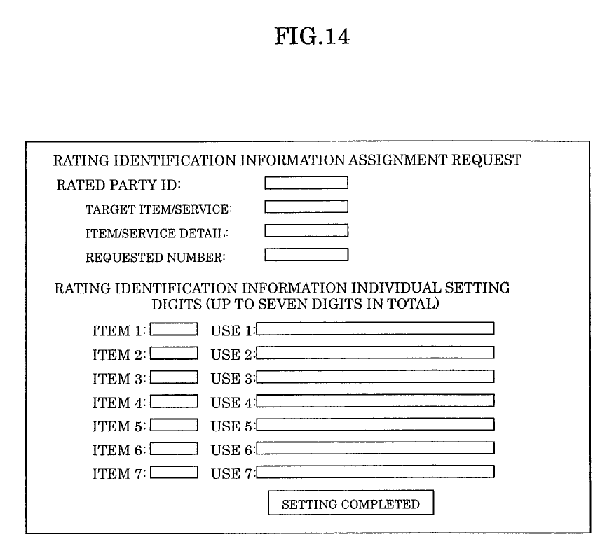

When it is confirmed that the password is correct at step S13, the server 100 transmits a form for inputting a rating identification information assignment request to the access terminal 201 (at step S14). The input screen for the rating identification information assignment request displayed on the screen of the access terminal 201 in this case is shown in FIG. 14.

In the flow of FIG. 13, the rated party “A” does not set the individual identification information. Therefore, without inputting columns of rating identification individual setting in the input screen of FIG. 14, the rated party “A” inputs only the rated party ID, the target product/service, the product/service detail, and the required number. In the example of FIG. 13, the rated party “A” inputs “rated party ID=B0001”, “target product/service=PC”, “product/service detail=notebook PC”, and “requested number=1000” (at step S15).

The server 100 determines whether or not the rating identification information assignment request is correct (at step S16). When it is incorrect, the server 100 requests a re-input of the rating identification information request (at step S24). Otherwise, the server 100 extracts the company code, the product/service code, and the product/service detail code respectively from the company code determination file, the product/service code determination file, and the product/service detail code determination file shown in FIGS. 10-12 at steps S17 and S18.

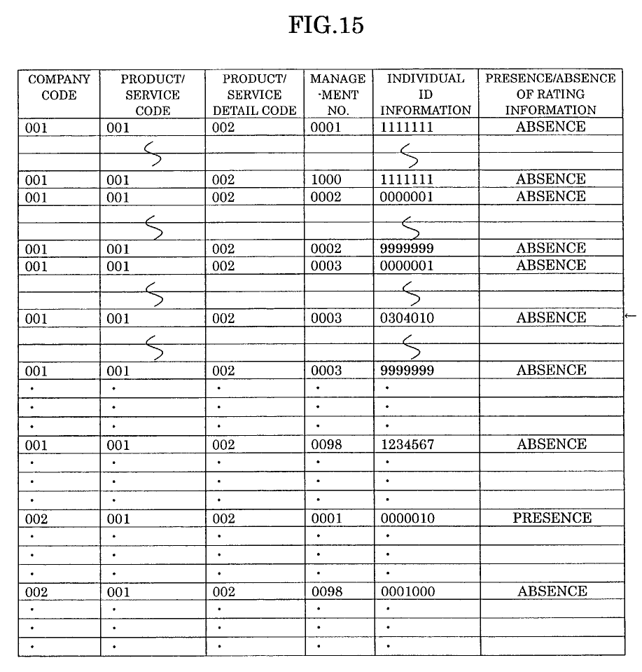

Moreover, the server 100 prepares the rating identification information including the codes obtained at steps S17 and S18, according to the inputted requested number (at step S19), registers the prepared rating identification information in a rating identification information management file as shown in FIG. 15 (at step S20), and notifies the rated party “A” of the facts (at step S21).

In this case, since “requested number=1000”, the rating identification information prepared at step S19 will be as shown in the rating identification information management file of FIG. 15, for example, as follows: “0010010020001-1111111-0010010021000-1111111”

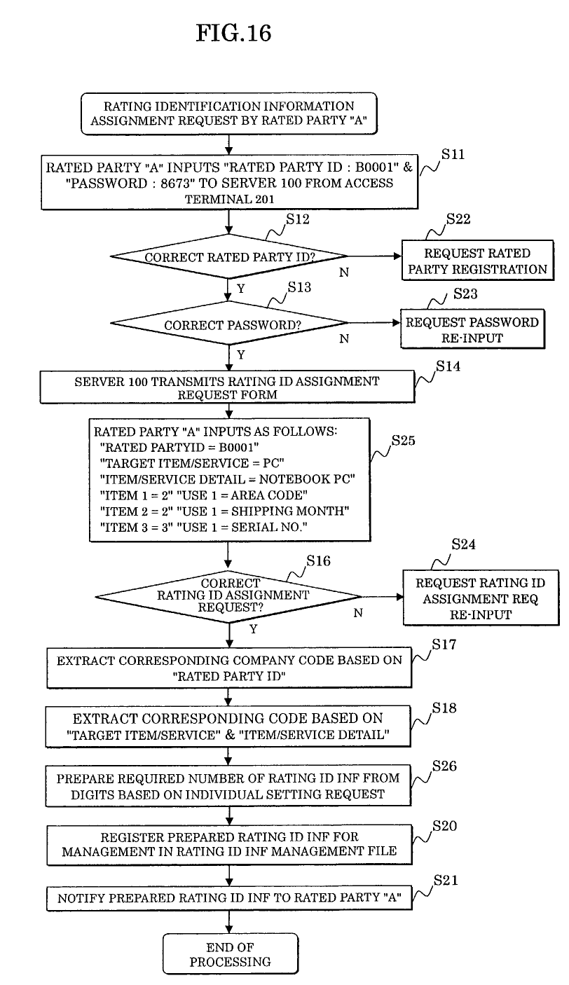

FIG. 16 shows a processing flow of the rating identification information assignment of the case with the individual identification information setting. In the processing flow shown in FIG. 16, steps S25 and S26 respectively substitute for steps S15 and S19 of the processing flow of FIG. 13, so that hereinafter only steps S25 and S26 will be described.

At step S25, in addition to the information of “rated party ID=B0001”, “target product/service=PC”, and “product/service detail-notebook PC”, the rated party “A” inputs as follows in items 1-3, and uses 1-3 of the rating identification information individual setting input screen shown in FIG. 14 in order to perform individual information setting:

“Item 1=2”, “Use 1=area code”

“Item 2=2”, “Use 2=shipping month”

“Item 3=3”, “Use 3=serial No.”

It is to be noted that in case of FIG. 16, the column of “required number” in FIG. 14 has no input.

At step S26 of FIG. 16, the server 100 prepares the rating identification information according to the number of the digits of the items inputted at step S25.

In this case, the total number of the digits is seven, so that the rating identification information prepared at step S25 assumes “0010010020003-0000001”-“0010010020003-9999999”.

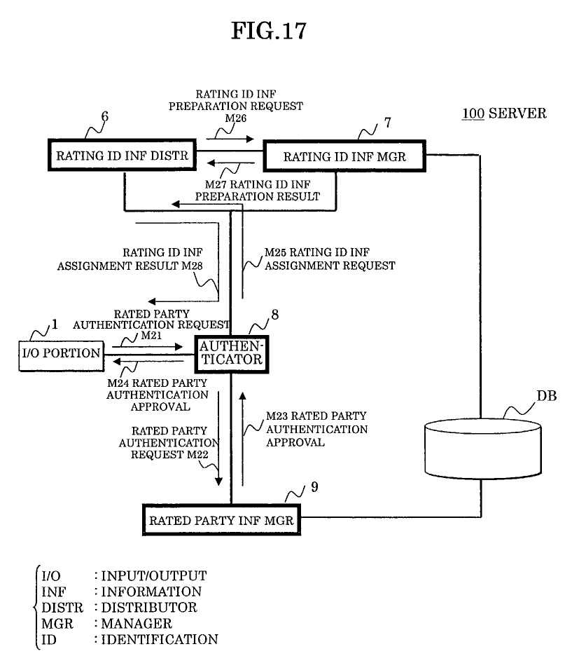

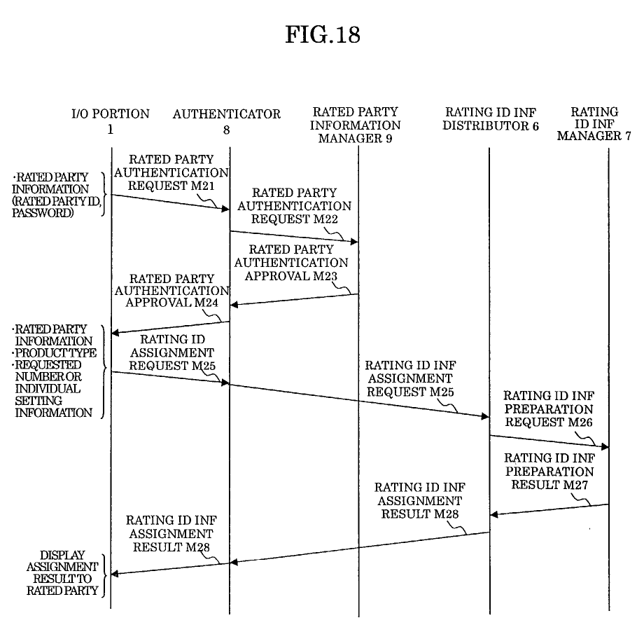

Hereinafter, operations of the portions in the server 100 will be described referring to FIGS. 17 and 18 where the above-mentioned rating identification information assignment flow is executed regardless of the presence/absence of the individual identification information setting, without performing the rated party registration request (at step S22 of FIGS. 13 and 16), the password re-input request (at step S23 of FIGS. 13 and 16), and the rating information request re-input request (at step S24 of FIGS. 13 and 16)

FIG. 17 shows components related to the assignment of the rating identification information to the rated party extracted from among the components of the server 100 shown in FIG. 1. FIG. 18 shows an operation sequence of FIG. 17.

Firstly, the I/O portion 1 edits a rated party authentication request M21 in which the rated party ID and the password preliminarily registered are set by the rated party to be transmitted to the authenticator 8.

The authenticator 8 transmits a rated party authentication request M22 in which the rated party ID and the password are set to the rated party information manager 9 in order to perform the rated party authentication.

The rated party information manager 9 retrieves the inputted rated party ID and the password from the rated party authentication file (see FIG. 9) in the database DB. When the corresponding rated party has been already registered, and the rated party ID and the password are authenticated, the rated party information manager 9 returns a rated party authentication approval M23 to the authenticator 8. In order to notify that the authentication has been completed normally, the authenticator 8 returns an authentication approval M24 to the I/O portion 1, thereby outputting the information that the authentication has been successful to the rated party.

Upon receiving a rating identification information assignment request from the rated party, the I/O portion 1 edits the rated party information, the type of target product/service, and the requested number or the individual setting information as a rating identification information assignment request M25 to be transmitted to the rating identification information distributor 6 through the authenticator 8 in order to acquire the rating identification information to be attached to the product and the service.

The rating identification information distributor 6 edits a rating identification information preparation request M26 for preparing the rating identification information based on the received rating identification information assignment request M25 to be transmitted to the rating identification information manager 7.

The rating identification information manager 7 prepares the rating identification information based on the rating identification information preparation request M26, and registers the rating identification information in the rating identifying management file (see FIG. 15) in the database DB as a target of management.

Subsequently, the rating identification information manager 7 sets the prepared rating identification information in a rating identification information preparation result M27 to be returned to the rating identification information distributor 6.

The rating identification information distributor 6 having received the rating identification information preparation result M27 extracts the rating identification information to be assigned to the product and the service as a rating identification information assignment result M28 to transmit the same to the I/O portion 1 through the authenticator 8.

The I/O portion 1 extracts the rating identification information from the received rating identification information assignment result M28 and outputs the rating identification information to the rated party.

(1-3) Registration of rating information inputted by rater

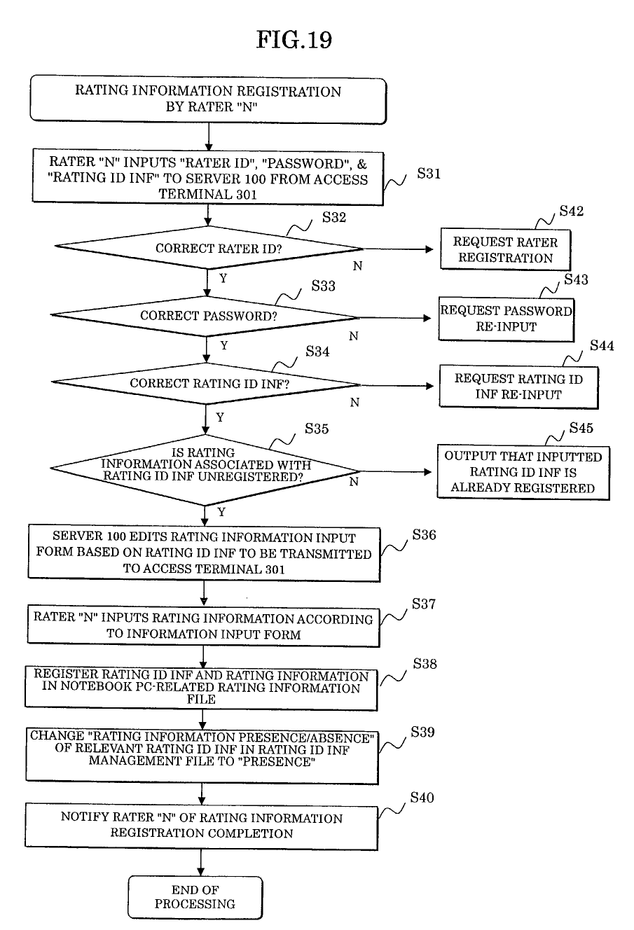

FIG. 19 shows, as an example of a registration flow of the rating information inputted by the rater, a case where the rater “N” (“rater ID=A0005” and “password=2446”) having already performed the rater registration by the above-mentioned (1-1) purchases a notebook PC of the rated party “A” and inputs the rating information to the server 100.

The rated party “A” has the rating identification information assigned by the server 100 by the above-mentioned (1-2), and the assigned rating identification information is further attached to the notebook PC-A to be sold, so that e.g. the rating identification information (001001002000-0304010) is assigned to the notebook PC-A of the rated party “A” which the rater “N” has purchased.

The rater “N” accesses the server 100 through an arbitrary network and shows its intention to perform rating the purchased product, for example by pressing a button on the screen. In response thereto, the server 100 presents a form for inputting “rater ID”, “password”, and “rating identification information”, in order to authenticate the rater (not shown).

The rater “N” inputs “rater ID=A0005” and “password=2446” issued at the time when it has preliminarily made the rater registration in the server 100 as well as “rating identification information=0010010020003-0304010” attached to the purchased notebook PC-A, to the server 100 by using the provided form (at step S31). The server 100 confirms whether or not the rater ID and the password are correct (at steps S32 and S33). When the rater ID is incorrect, the server 100 requests the rater registration (at step S42). Otherwise, the server 100 requests a password re-input (at step S43).

Moreover, the server 100 confirms whether or not the rating identification information is correct (at step S34). When it is incorrect, the server 100 requests a rating identification information to be re-inputted (at step S44). Subsequently, the server 100 confirms whether or not the rating information associated with the rating identification information is unregistered (at step S35). When the rating identification information has been already registered, the fact is notified to the rater “N” (at step S45).

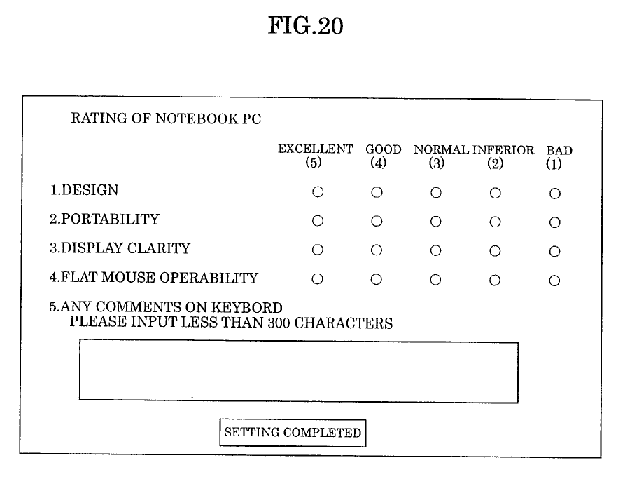

After confirming that the rating information is unregistered at step S35, the server 100 edits an input form based on the inputted rating identification information to be presented to the rater (at step S36). In this case, a rating information input screen of the notebook PC as shown in FIG. 20 is displayed on the access terminal of the rater “N”.

The rater “N” inputs e.g. the following rating information to server 100 according to the form (at step S37):

“design=3”

“portability=4”

“display clarity=5”

“flat mouse operability=4”

“comments on keyboard=key touch is very satisfying”

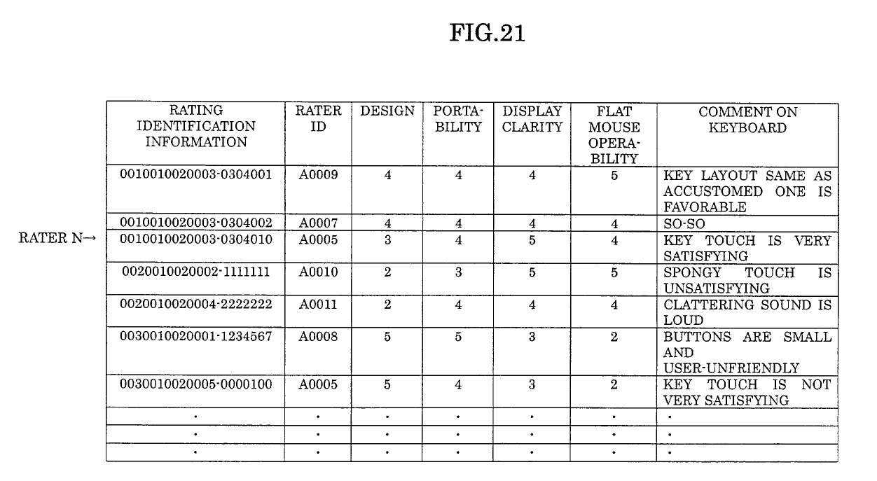

The server 100 registers the inputted information in a notebook PC-related rating information file as shown in FIG. 21 (at step S38), and changes the “presence/absence of rating information” of the relevant rating identification information in the rating identification information management file of FIG. 15 to “presence” (at step S39), and notifies the registration completion of the rating information to the rater “N” (at step S40).

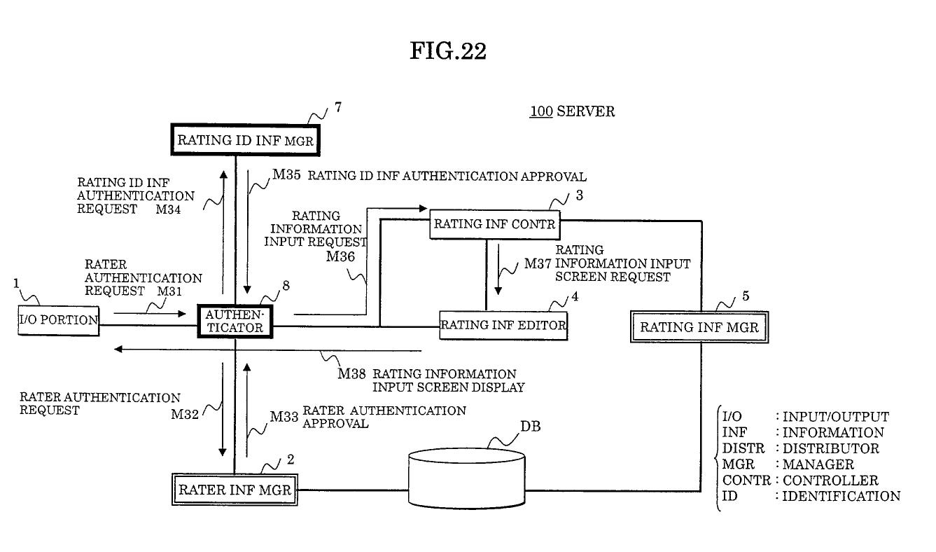

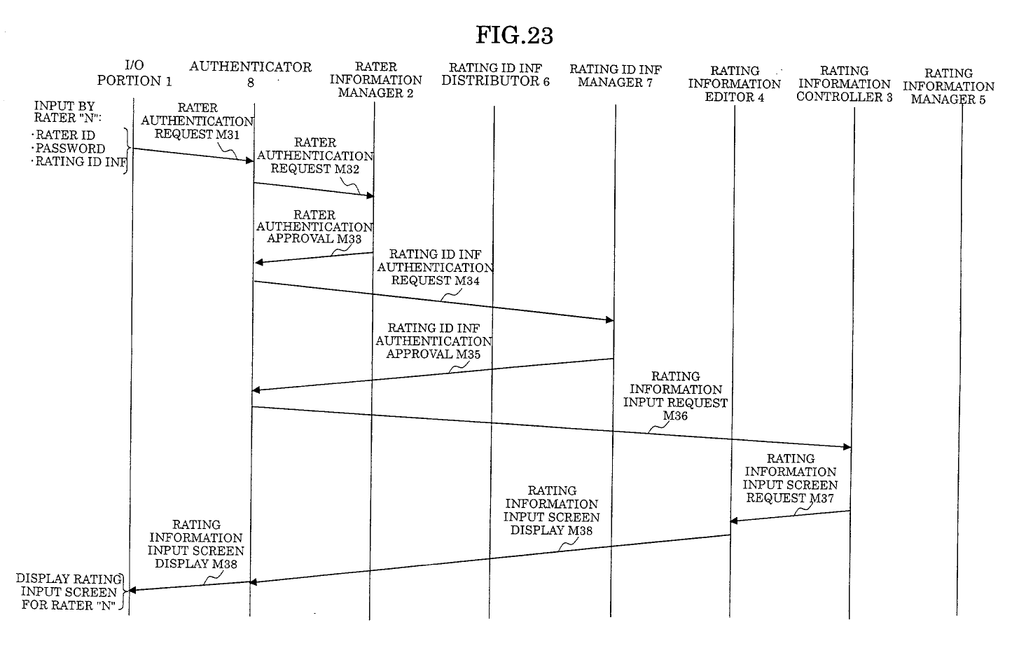

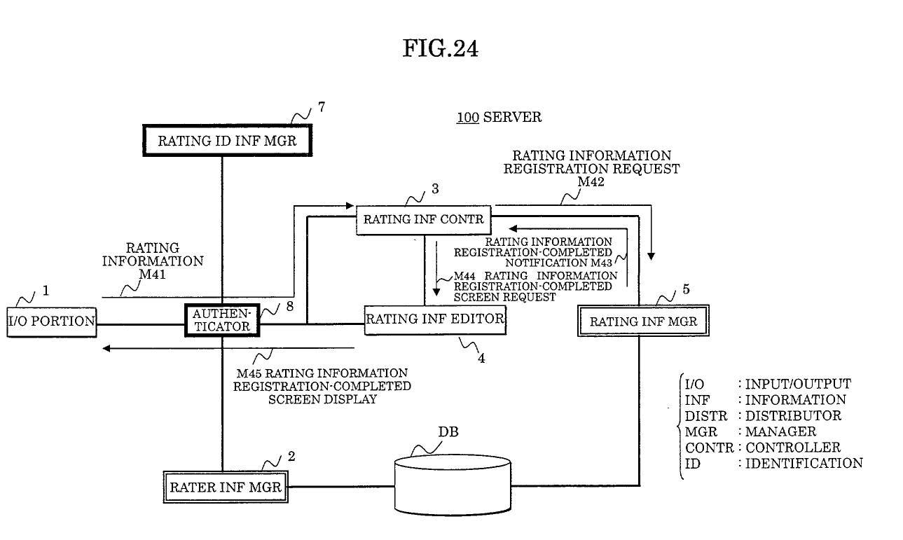

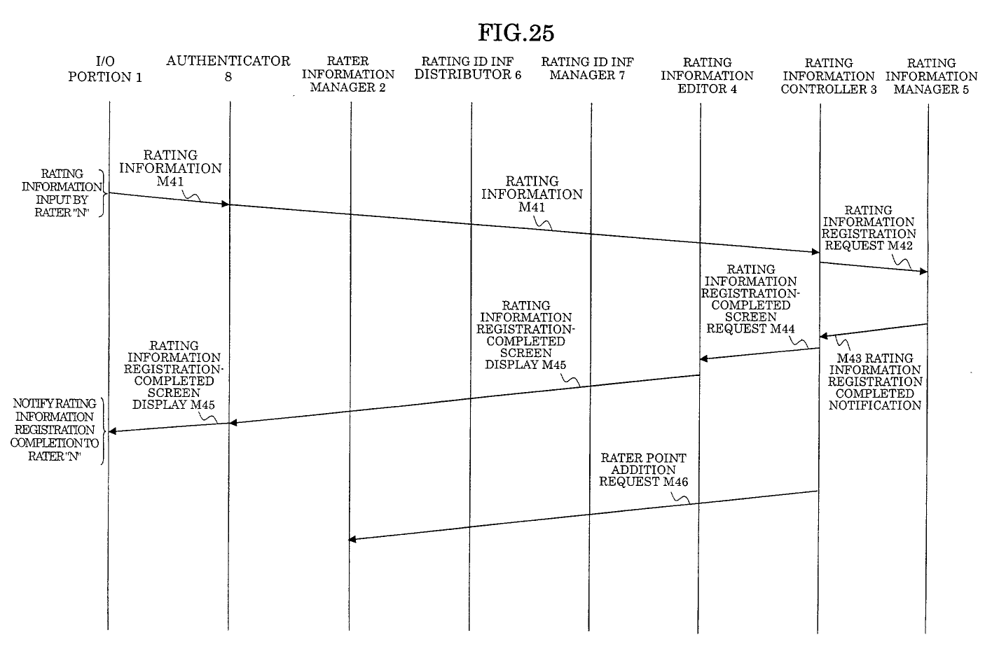

Hereinafter, operations of the portions in the server 100 when the processing flow of above-mentioned rating information registration is executed will be described referring to FIGS. 22-25. It is to be noted that FIGS. 22 and 24 respectively show the components related to steps S31-S36 and steps S37-S40 of FIG. 19 extracted from among the components of the server 100. FIGS. 23 and 25 show respective operation sequences of FIGS. 22 and 24.

Firstly, upon receiving the input of the rater ID, the password, and the rating identification information from the rater, the I/O portion 1 sets the same in a rater authentication request M31 to be transmitted to the authenticator 8. The authenticator 8 having received the rater authentication request M31 extracts the rater ID and the password from the rater authentication request M31, and sets the same in a rater authentication request M32 to be transmitted to the rater information manager 2.

The rater information manager 2 having received the rater authentication request M32 uses the rater authentication file (see FIG. 5) in the database DB to authenticate the rater ID and the password. When they are authenticated, the rater information manager 2 returns a rater authentication approval M33 to the authenticator 8.

The authenticator 8 having received rater authentication approval M33 thereafter transmits a rating identification information authentication request M34 to the rating identification information manager 7 in order to verify the rating identification information set in the rater authentication request M31.

Having verified that the rating identification information set in the rating identification information authentication request M34 has been registered in the rating identification information management file (see FIG. 15) in the database DB and that the rating identification information is unregistered, the rating identification information manager 7 transmits a rating identification information authentication approval M35 to the authenticator 8.

Subsequently, the authenticator 8 transmits a rating information input request M36 for allowing the rater to input the rating information to the rating information controller 3.

The rating information controller 3 transmits a rating information input screen request M37 in which the rating identification information is set, to the rating information editor 4, in order to display the rating information input screen.

The rating information editor 4 having received the rating information input screen request M37 analyzes the common identification information in the rating identification information in order to edit a rating information input screen.

For example, when “common identification=0010010020003”, it is found that “product/service code” in the rating identification information format shown in FIG. 7 is “001”, and “product/service detail code” is “002”, so that it is determined that the code corresponds to the code of the notebook PC by referring to the product/service code determination file (see FIG. 11) and the product/service detail code determination file (PC-related) (see FIG. 12).

Therefore, the rating information editor 4 edits a notebook PC rating information input screen shown in FIG. 20, that is a rating format related to notebook PC, as a rating information input screen display M38 to be transmitted to the I/O portion 1 through the authenticator 8.

After the rating information input screen is thus displayed, the rater inputs the rating information.

The I/O portion 1 transmits the rating information inputted by the rater as rating information M41 to be transmitted to the rating information controller 3 through the authenticator 8. The rating information controller 3 edits the received rating information M41 for a registration as a rating information registration request M42 to be transmitted to the rating information manager 5.

The rating information manager 5 extracts the rating information from the received rating information registration request M42 to be registered in the database DB, and then returns a rating information registration-completed notification M43 for notifying the completion of the registration to the rating information controller 3.

The rating information controller 3 requests a screen display for notifying that the rating information is successfully registered as a rating information registration-completed screen request M44 to be transmitted to the rating information editor 4.

The rating information editor 4 edits screen information showing the registration completion as a rating information registration-completed screen display M45 to be transmitted to the I/O portion 1 through the authenticator 8.

While in this embodiment, the rating identification information uses a 20-digit character string, the rating identification information is not limited to a character string but may be any information which can be authenticated when the rater having purchased the product or the service of the rated party inputs the rating information, so that identification information of high security such as a “two-dimensional code” or a “tag” may be used.

Embodiment (2)

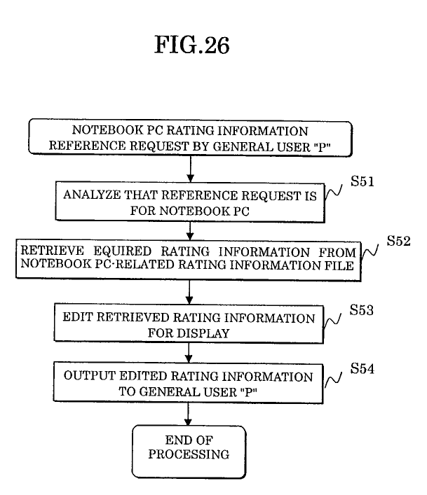

Next, as an embodiment (2), a rating information reference flow by an arbitrary general user will be described referring to FIG. 26.

A case where a general user “P” who is not registered as a rater in the server 100 refers to rating information related to notebook PC as an example of an arbitrary user referring to the rating information registered in the server from an arbitrary access terminal, such as the access terminals 201-203 and 301-304 shown in FIG. 2, connectable to the server 100.

Firstly, the server 100 analyzes that the general user “P” is requesting the rating information of the notebook PC (at step S51 of FIG. 26), and retrieves required rating information from the notebook PC-related rating information file (see FIG. 21) (at step S52 of FIG. 26). Then, the server 100 edits the retrieved rating information for display (at step S53), and outputs the edited rating information (at step S54).

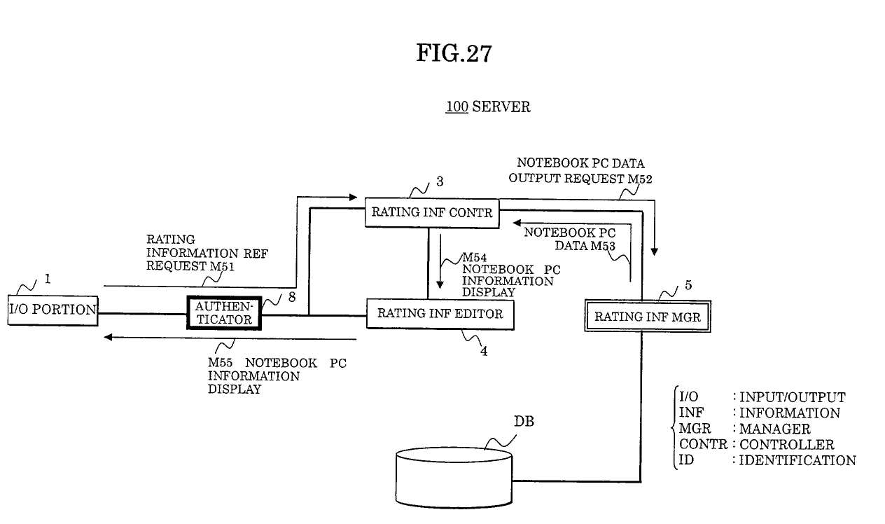

Hereinafter, operations of the portions in the server 100 in this case will be described referring to FIG. 27.

Firstly, the I/O portion 1 sets the reference request in a rating information reference request M51 to be transmitted to the rating information controller 3 through the authenticator 8.

The rating information controller 3 analyzes that the reference request is related to the notebook PC from the received rating information reference request M51, transmits a notebook PC data output request M52 to the rating information manager 5 in order to request the output of the notebook PC-related data.

The rating information manager 5 searches the notebook PC-related rating information file based on the received notebook PC data output request M52 and returns a notebook PC data M53 to the rating information controller 3.

After analyzing the received notebook PC data M53, the rating information controller 3 transmits a notebook PC information display M54 to the rating information editor 4 in order to display a screen.

The rating information editor 4 edits the received notebook PC information display M54 as a notebook PC information display M55 to be outputted to the I/O portion 1 through the authenticator 8.

The above-mentioned rating information reference flow is almost the same as the sequence of the prior art described referring to FIG. 36. However, since the rating information registered in the server 100 is registered by the method described in the embodiment (1), it is made possible to refer to higher reliable information compared to the prior art.

Embodiment (3)

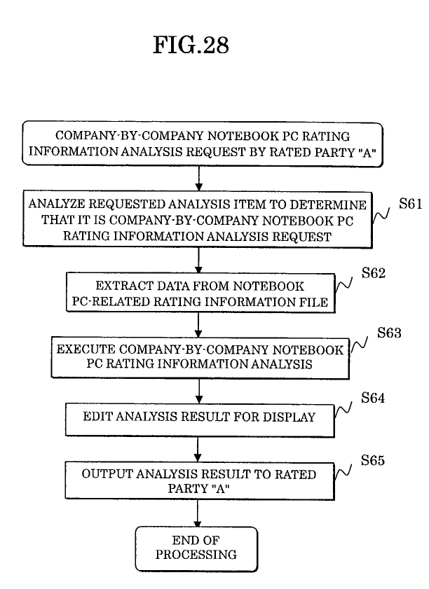

Next, as an embodiment (3), a processing flow in case the rated party “A” requests the company-by-company analysis of the rating information related to the “notebook PC” in order to make a comparison with the other companies, as an example, will be described referring to FIG. 28.

The server 100 having received an analysis request from the rated party “A” determines that it is the notebook PC-related information analysis request for comparison with the other companies (at step S61), and extracts the notebook PC-related rating information from the database DB (at step S62) to be analyzed (at step S63). Moreover, the server 100 edits the analysis result for display (at step S64) to be outputted to the rated party “A” (at step S65).

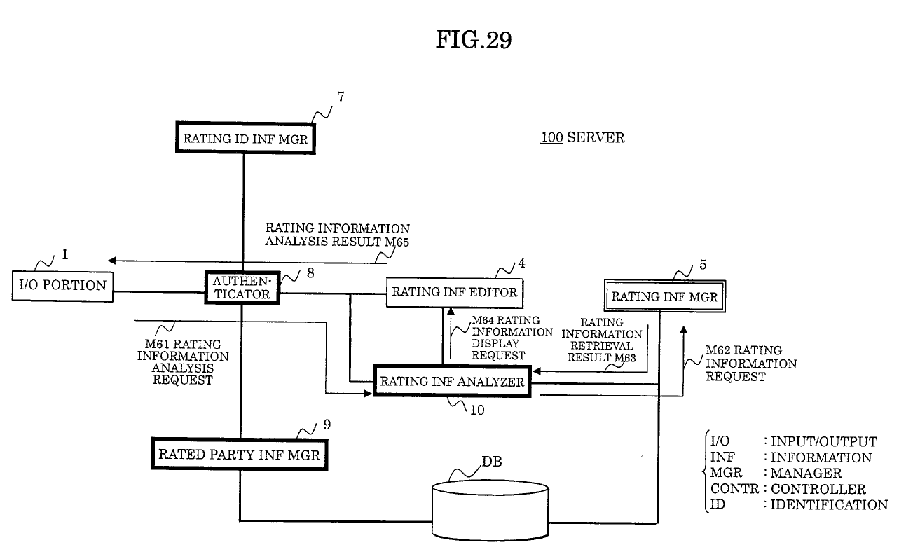

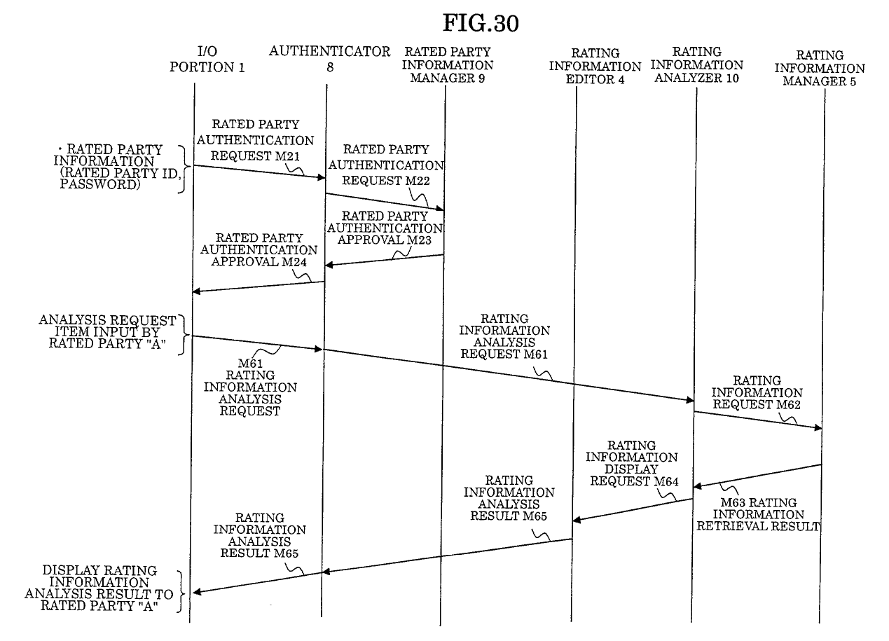

Operations of the portions in the server 100 in above-mentioned flow will be described referring to FIGS. 29 and 30. FIG. 29 shows the components related to the rating information analysis extracted from among the components of the server 100 shown in FIG. 1. FIG. 30 shows a processing sequence thereof.

Firstly, the I/O portion 1 having received a rating information analysis request from the rated party “A” edits a rating information analysis request M61 to be transmitted to the rating information analyzer 10 through the authenticator 8.

The rating information analyzer 10 analyzes the received rating information analysis request M61 in order to obtain the required rating information. For example, when the rating information analyzer 10 determines that it is the analysis request for “company-by-company notebook PC-related rating information comparison”, the rating information analyzer 10 transmits the notebook PC-related rating information as a rating information request M62 to the rating information manager 5.

The rating information manager 5 searches the notebook PC-related rating information file (see FIG. 21) in the database DB in order to take out notebook PC-related rating information based on the received rating information request M62, and sets the retrieval result in a rating information retrieval result M63 to be returned to the rating information analyzer 10.

The rating information analyzer 10 analyzes the received rating information retrieval result M63, and prepares a rating information display request M64 to be transmitted to the rating information editor 4 in order to output the display of a rating result.

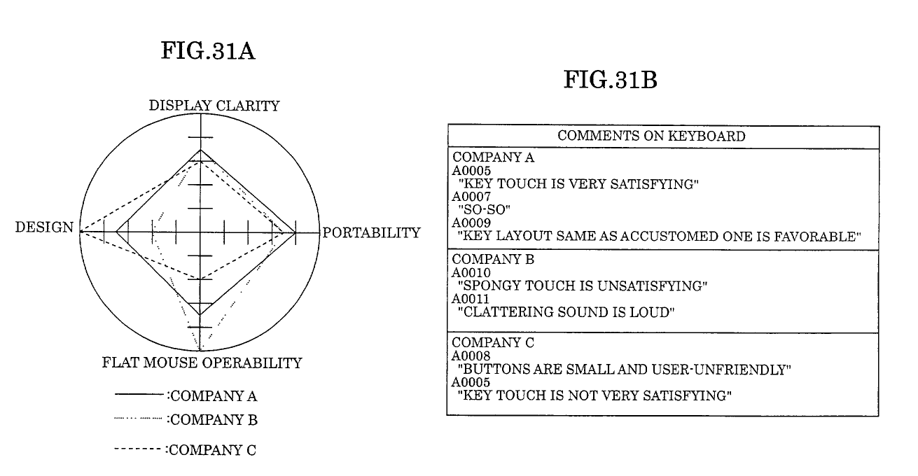

The rating information editor 4 extracts the rating result from the rating information display request M64 and edits the rating result as the notebook PC company-by-company comparison result shown in FIGS. 31A and 31B, to be transmitted as a rating information analysis result M65 to the I/O portion 1 through the authenticator 8.

The I/O portion 1 outputs the rating information analysis result M65 with the rating result set therein to the rated party “A”.

FIG. 31A shows a graph of company-by-company comparison for a design, a portability, a display clarity, and a flat mouse operability. FIG. 31B shows comments on keyboard per company.

Thus, the rated party can obtain a useful analysis result of the rating information. It is to be noted that, as shown in FIG. 30, in order to allow only the pre-registered rated party to obtain the analysis result, a sequence where the authenticator 8 and the rated party information manager 9 authenticates the rated party by using the rated party authentication requests M21 and M22 and the rated party authentication approvals M23 and M24 may be added.

While this embodiment (3) has referred to a case where the requestor requesting the analysis of the rating information is the rated party, the requestor only need be preliminarily registered in the server 100, and may be a rater or a third party that corresponds to neither the rater nor the rated party.

In this case, the server 100 has only to perform the authentication of the requestor by using the rater information manager 2 or the third party information manager 14 instead of the rated party information manager 9 in the above-mentioned description. However, if the requestor is the third party, third party information (e.g. third party ID and password) is supposed to be preliminarily registered in a third party authentication file (not shown) similar to the rated party authentication file of FIG. 9.

Moreover, the analysis may be priced and charged to the requester that requests the analysis.

Embodiment (4)

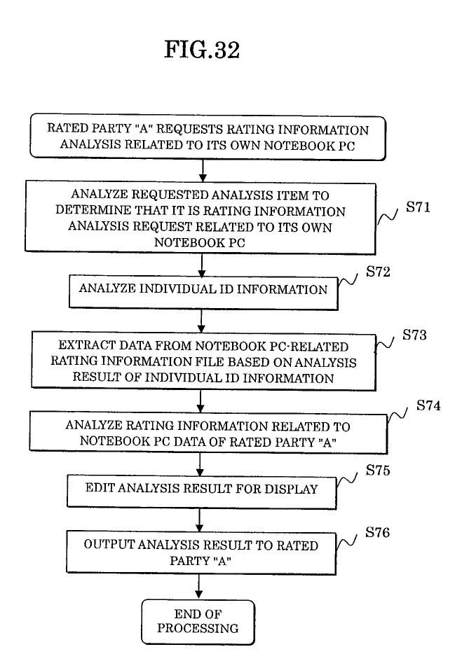

Next, as an embodiment (4), a flow in case the rated party “A” analyzes the rating information related to its own notebook PC will be described referring to FIG. 32.

The server 100 having received an analysis request from the rated party “A” determines that it is the rating information analysis request related to the notebook PC of the rated party “A” (at step S71), and analyzes the individual identification information (at step S72). Moreover, the server 100 extracts required rating information related to the notebook PC of the rated party “A” based on the analysis result of the individual identification information from the database DB (at step S73) to be analyzed (at step S74). Moreover, the server S100 edits the analysis result for display (at step S75) to be outputted to the rated party “A” (at step S76).

In this case, operations of the portions in the server 100 are the same as those of the embodiment (3). For example, a case where the company “A” makes an analysis request to the server 100 in order to see the trend of the rater (purchaser) who has purchased the notebook PC of the company “A” itself, by “area code=002” and “shipping month=003” of the individual identification code will be described. The rating information analyzer 10 having received the rating information analysis request M61 in FIGS. 29 and 30 determines that the request is the analysis request related to the individual identification information, and transmits a rating information request M62 to the rating information manager 5 in order to request rating information of data related to the notebook PC of the company “A” with “area code=002” and “shipping month=003”.

Also, the rating information manager 5 retrieves the rating information with “area code=002” and “shipping month=003” for the notebook PC of the company “A” from the notebook PC related rating information file within the database DB and sets the result in the rating information retrieval result M63 to be returned to the rating information analyzer 10.

In the same way as in the above-mentioned embodiment (3), the rating information analyzer 10 analyzes the received rating information retrieval result M63, and prepares the rating information display request M64 in order to output the rating result to be transmitted to the rating information editor 4.

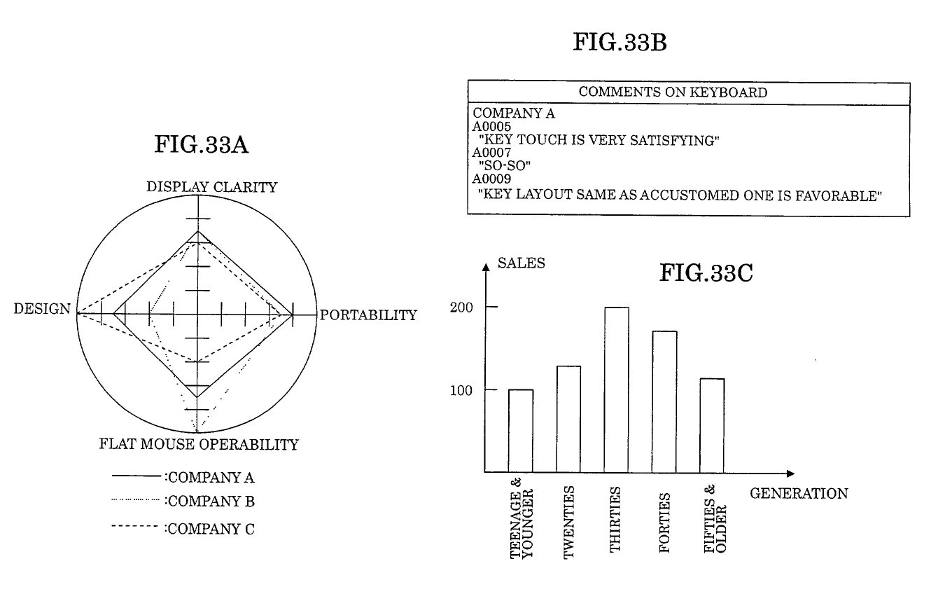

The rating information editor 4 extracts the rating result from the rating information display request M64, and edits the rating result for a display on the screen as shown in analysis result by individual identification information of the notebook PC of the company “A” shown in FIGS. 33A-33C to be transmitted as a rating information analysis result M65 to the I/O portion 1 through the authenticator 8.

FIGS. 33A and 33B show similar rating contents as FIGS. 31A and 31B, only for the notebook PC of the rated party “A”. Moreover, in FIG. 33C, sales numbers by generations of the raters according to the setting of the individual identification information set by the rated party “A” are shown in the form of graph.

In this case, the rater information registered in the rater authentication file is used as the age of the rater (see FIG. 5).

In this embodiment (4), like the above-mentioned embodiment (3), a rating information analysis request may be made by a requester other than the rated party.

Embodiment (5)

Next, as an embodiment (5), a case where an arbitrary user requests an analysis of the rating information in the same way as the rated party “A” in the above-mentioned embodiment (3) or (4) will be described. In this case, processing flows are the same as those shown in FIGS. 28 and 32. However, only the subject that requests the analysis is changed from the rated party “A” to e.g. the general user “P”.

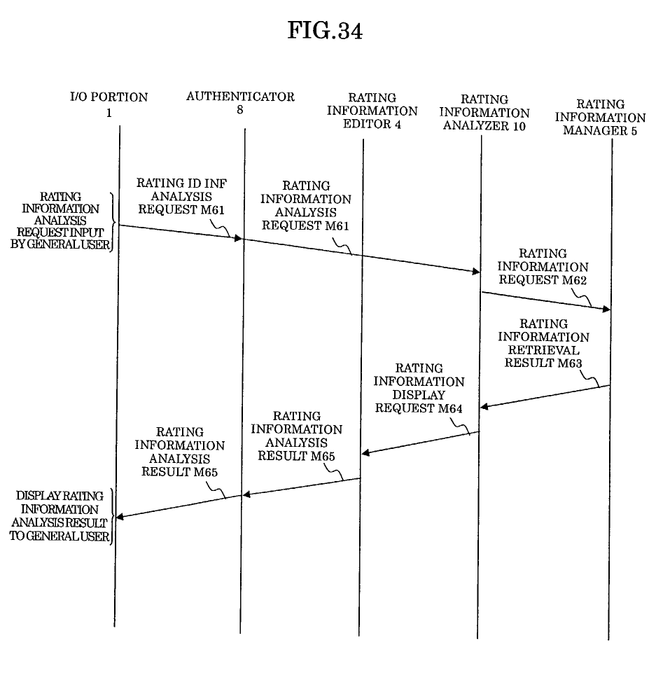

Also, FIG. 34 shows an operation sequence of the portions in the server 100 which is the same as that of FIG. 30. However, this embodiment (5) allows a rating information analysis to be requested by the arbitrary user. Therefore, FIG. 34 is different from FIG. 30 in that an authentication of a requesting party of the analysis is not performed.

Embodiment (6)

Next, as an embodiment (6), a case where rater points are provided as incentives to a rater that continuously inputs the rating information will be described.

It is assumed that when the rater requests registration of the rating information by the processing flow shown in FIG. 19, the rating information manager 5 transmits the rating information registration-completed notification M43 to the rating information controller 3 in FIG. 25.

While the rating information controller 3 transmits the rating information registration-completed screen request M44 for displaying the registration-completed screen to the rating information editor 4, in the above-mentioned embodiment (1), the rating information controller 3 further transmits a rater point addition request M46 to the rating information manager 2 in order to add the rater points to the rater who has inputted the rating information in the embodiment (6).

The rating information manager 2 having received the rater point addition request M46 makes an addition to the rater points of the corresponding rater in the rater authentication file (see FIG. 5).

Thus, by having a mechanism allowing a grant of incentives profitable to the rater who registers the rating information to the server 100, it is made possible to provide a reliable rating system which motivates a continued rating by a rater (general user) and retains the raters.

Embodiment (7)

Next embodiment (7) utilizes the rating information and the rater information accumulated in the server 100 according to the above-mentioned embodiments (1)-(6) to deal with:

(7-1) Extraction of specific rater;

(7-2) Distribution of distributing information for the specific rater; and

(7-3) Collection of response information for the distributing information.

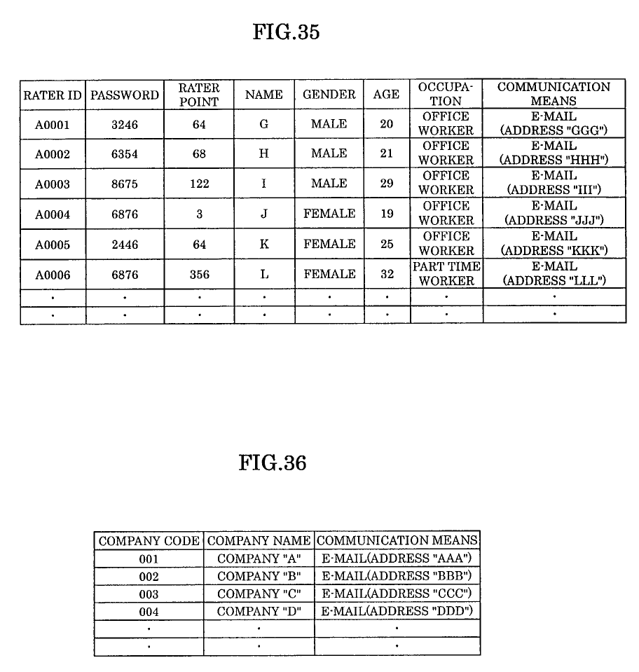

As a precondition of this embodiment (7), a rater authentication file as shown in FIG. 35 is supposed to have been stored in the database DB. In FIG. 35, the item shown as “rater private information” in the rater authentication file of FIG. 5 referring to the description of the embodiment (1) is more specifically shown as “name”, “gender”, “age”, “occupation”, and “communication means”. FIG. 35 shows specific examples related to the raters whose rater ID's are “A0001”-“A0006”. For example, the rater ID “A0001” has the name “G”, is a male office worker in his twenties, and uses E-mail (address “GGG”) as the communication means.

Also, for a company code determination file used in this embodiment (7), one shown in FIG. 36 is supposed to be used. This is different from the company code determination file of FIG. 10 in which “company code” and “rated party ID” used in the above-mentioned embodiment (1) are associated with each other in that “company code”, “company name”, and “communication means” are associated with each other.

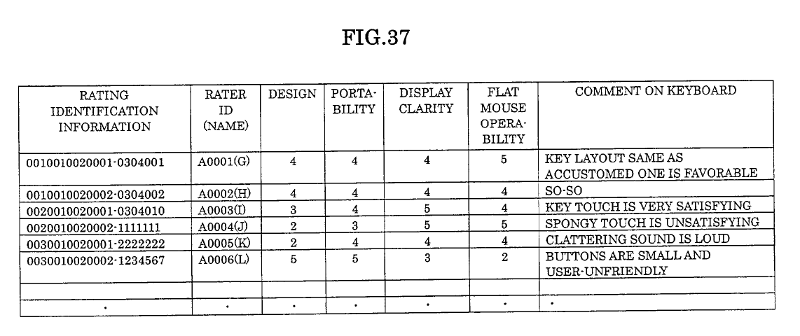

Also, as a notebook PC-related rating information file used in this embodiment (7), one shown in FIG. 37 is supposed to have been stored in the database DB. While FIG. 37 shows a similar file as that shown in FIG. 21, examples of rating information by the above-mentioned raters whose rater ID's are “A0001”-“A0006” are shown suitable for the description of this embodiment.(7).

Referring to the company code determination file of FIG. 36, since the upper or significant three digits of the rating identification information of the notebook PC-related rating information file of FIG. 37 are the codes “001”, “002”, and “003” respectively indicating a company “A”, a company “B”, and a company “C”, Mr.G and Mr.H that are the raters are recognized that they have purchased the notebook PC of the company “A” that is the rated party.

Similarly, Mr.I and Mr.J have purchased notebook PC's of the company “B”, while Mr.K and Mr.L have purchased notebook PC's of the company “C”.

Under the preconditions mentioned above, a case is assumed where the company “A” that is the rated party performs a questionnaire of notebook PC replacement purchase plans aimed at male office workers in their twenties with a record of notebook PC purchase.

(7-1) Extraction of specific rater

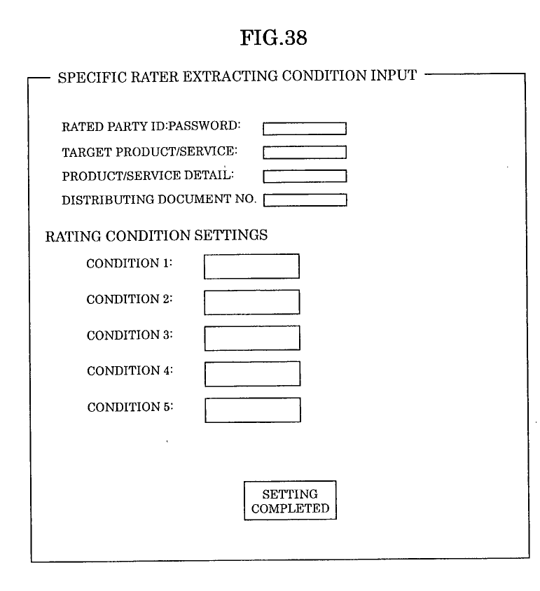

Firstly, the company “A” inputs the following information from a specific rater extracting condition input screen shown in FIG. 38 that is displayed on the screen of the access terminal 201 (see FIG. 2):

“target product/service=PC”

“product/service detail=notebook PC”

“condition 1=twenties”

“condition 2=male”

“condition 3=office worker”

“distributing document No.=1000”

After the above-mentioned input, the above-mentioned rater extracting conditions are transmitted to the server 100 by pressing the “setting completed” button.

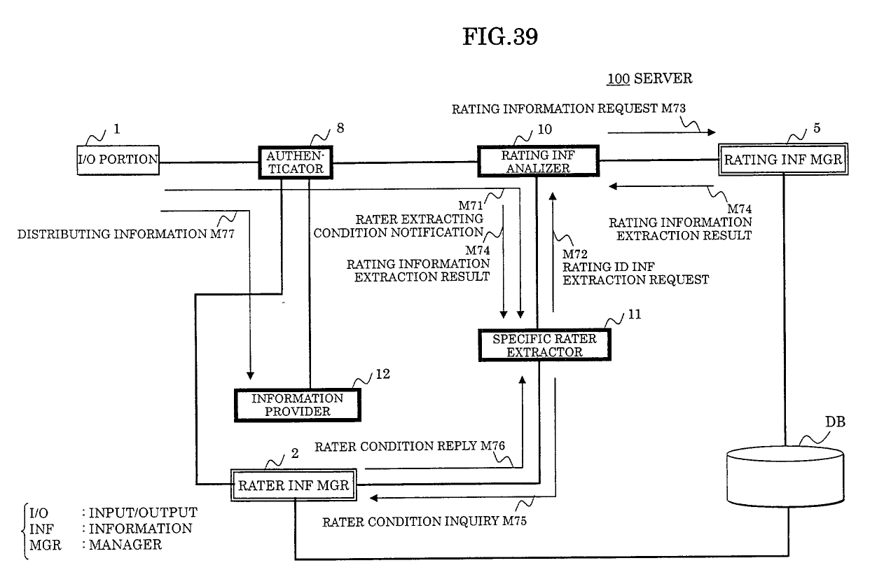

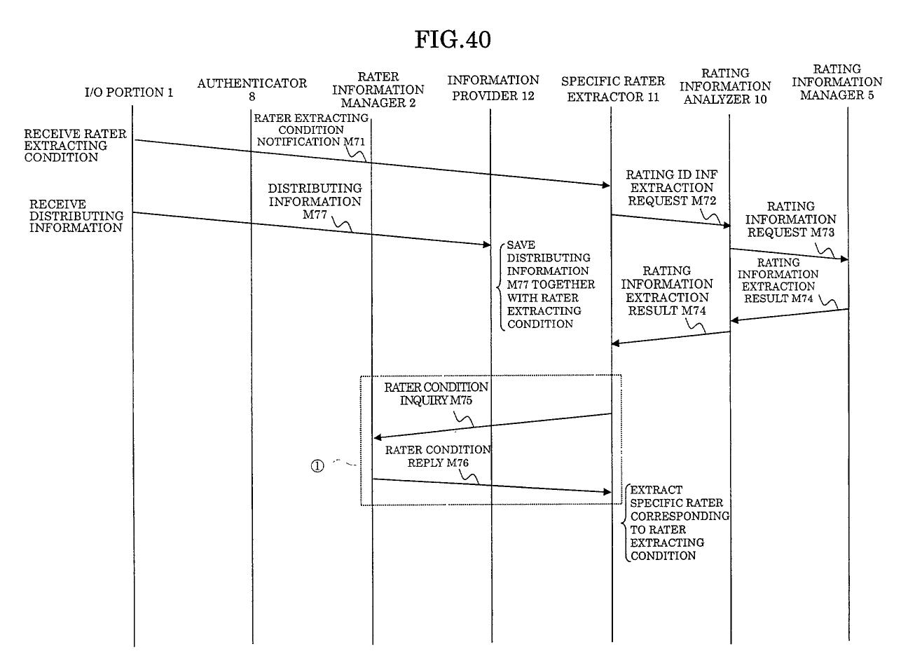

Hereinafter, the operation of the server 100 after receiving the above-mentioned rater extracting conditions until the specific rater corresponding to these conditions is extracted by the server 100 will be described referring to FIGS. 39 and 40. It is to be noted that FIG. 39 shows the components related to the extraction of the specific raters selected from among the components of the server 100 shown in FIG. 1, and FIG. 40 shows the operation sequence of FIG. 39.

Firstly, upon receiving the above-mentioned rater extracting conditions, the I/O portion 1 of the server 100 edits a rater extracting condition notification M71 where the designated conditions “PC”, “notebook PC”, “twenties”, “male”, “office worker”, and “distributing document No.=1000” are set to be transmitted to the specific rater extractor 11.

The specific rater extractor 11 extracts “PC” and “notebook PC” as conditions related to the rating identification information and the rating information from the received rater extracting condition notification M71, respectively, and edits a rater identification information extraction request M72 to be transmitted to the rating information analyzer 10.

The rating information analyzer 10, based on the rating identification information extraction request M72, transmits a rating information request M73 in which “PC” and “notebook PC” are set as the extracting conditions to the rating information manager 5.

The rating information manager 5 having received the rating information request M73 retrieves the notebook PC-related rating information file (see FIG. 37) in the database DB under the conditions of “PC” and “notebook PC”, extracts the rater ID's of the raters corresponding to the conditions “A0001(Mr.G)”, “A0002(Mr.H)”, “A0003(Mr.I)”, “A0004(Mr.J)”, “A0005(Mr.K)”, and “A0006(Mr.L)”. These rater ID's are set in a rating information extraction result M74 as the extraction result, and transmitted to the rating information analyzer 10. The rating information analyzer 10 further returns the rating information extraction result M74 to the specific rater extractor

Next, the specific rater extractor 11 extracts the conditions “twenties”, “male”, and “office worker” as conditions of the rater from the rater extracting condition notification M71, and edits a rater condition inquiry M75 by combining these conditions with the rater ID's in the received rating information extraction result M74, and transmits it to the rater information manager 2.

The rater information manager 2 having received the rater condition inquiry M75 determines whether or not the inquired rater ID corresponds to the conditions “twenties”, “male” and “office worker” by referring to the rater authentication file (see FIG. 35) in the database DB, and transmits the result as a rater condition response M76 to the specific rater extractor 11.

In this embodiment (7), the rater ID's of the above-mentioned six persons are included in the rating information extraction result M74, so that the processing of the portion \hat{1} surrounded by a dotted line in FIG. 40 is repeated six times.

As seen from the rater authentication file of FIG. 35, in case of this embodiment (7), from among rater ID's “A0001”, “A0002”, “A0003”, “A0004”, “A0005”, and “A0006”, 3 persons, “Mr.G” whose rater ID is “A0001”, “Mr.H” whose rater ID is “A0002”, and “Mr.I” whose rater ID is “A0003” are extracted as the specific raters corresponding to “twenties”, “male”, and “office worker”.

(7-2) Distribution of distributing information to the specific rater

Hereinafter, a case where distributing information is distributed to the specific raters extracted by the above-mentioned (7-1) will be described.

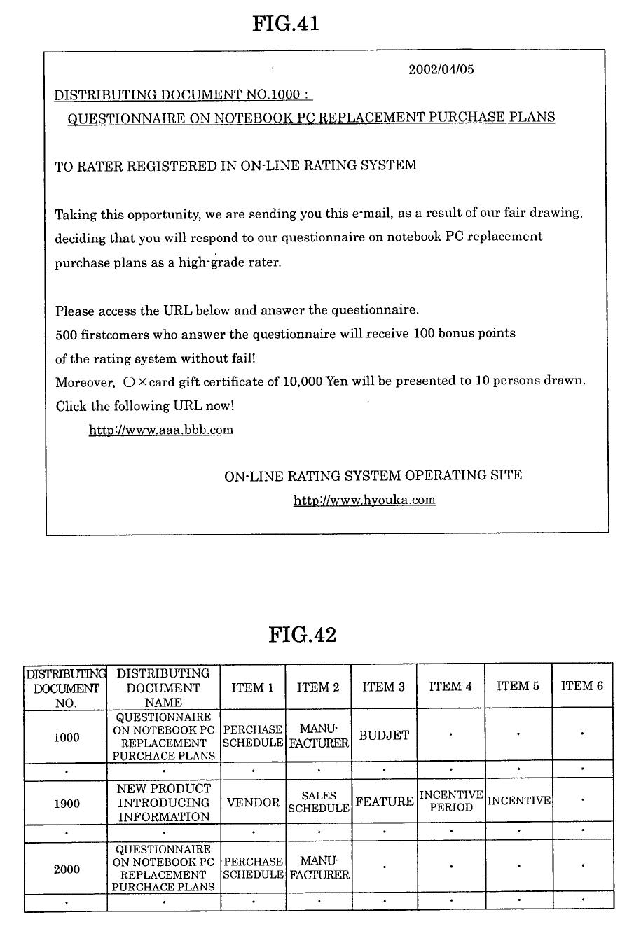

While FIGS. 39 and 40 show distributing information M77 as the information received by the I/O portion 1 of the server 100, “questionnaire on notebook PC replacement purchase plans” shown in FIG. 41 will be used in this embodiment (7) as a specific example of the distributing information M77.

It is to be noted that the distributing information is not limited to questionnaire, but may be any information such as various event information, new product information, that may be highly possible to match the needs and interest, fond, taste of the rater, or may be the information that enables the advertising activities of high marketing effects for the rated party.

The “questionnaire on notebook PC replacement purchase plans” shown in FIG. 41 is associated with the “distributing document No.:1000”. As shown in FIGS. 39 and 40, in the server 100, the distributing information M77 received by the I/O portion 1 is passed to the information provider 12 to be stored as a distributing document file in the database DB. FIG. 42 shows an example of the distributing document file. As shown, “distributing document No.” is associated with “distributing document name”, and further associated with “item 1”-“item 6” depending on the contents of the distributing document.

It is to be noted that other than the items shown in FIG. 42, the specific rater extracting conditions (e.g. “PC”, “notebook PC”, “twenties”, “male”, and “office worker”) may be associated with the “distributing document No.”.

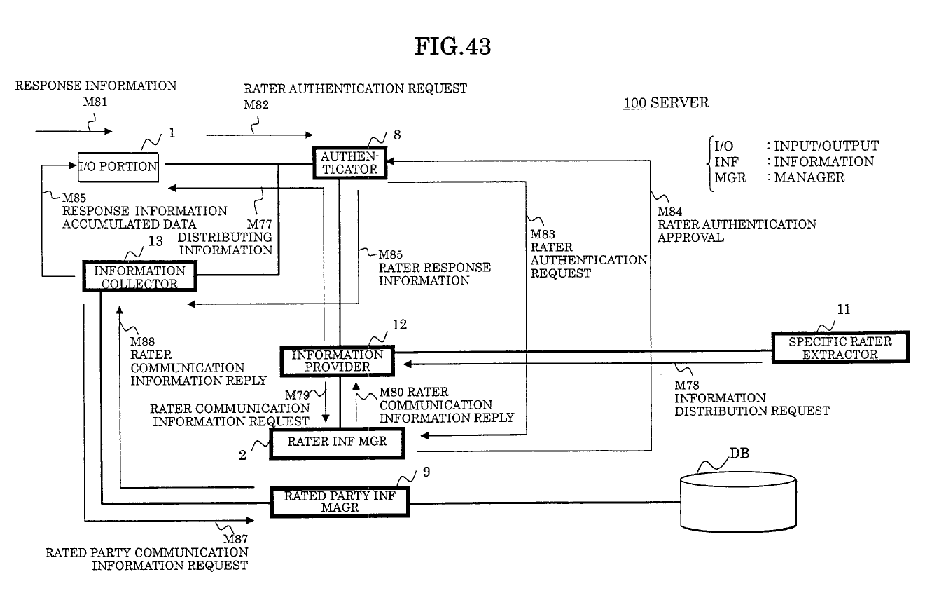

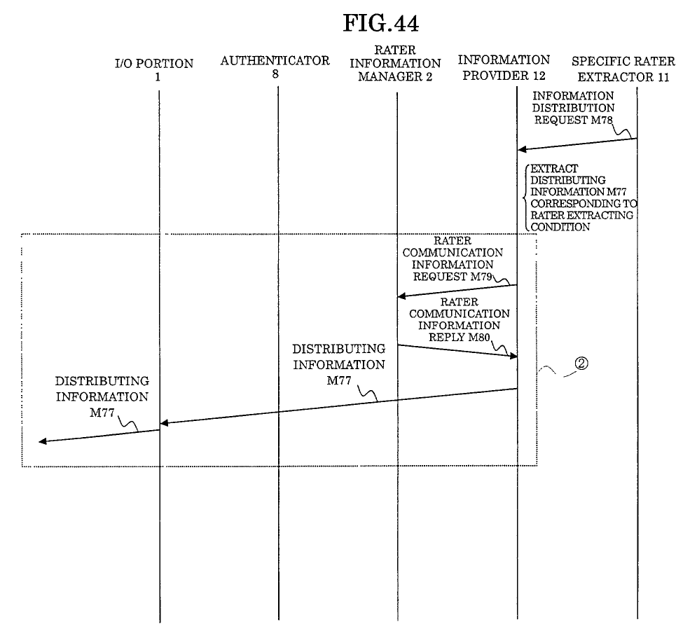

Hereinafter, the operation of the server 100 in the case where the distributing information is distributed to the specific raters extracted by the above-mentioned (7-1) will be described referring to FIGS. 43 and 44. It is to be noted that FIG. 43 shows the components related to the distribution of the distributing information and the reception of the response information extracted from among the components of the server 100 shown in FIG. 1. FIG. 44 shows an operation sequence of FIG. 43 related to the distribution of the distributing information.

The specific rater extractor 11 transmits, to the information provider 12, an information distribution request M78 designating the extracted specific raters “Mr.G”, “Mr.H”, and “Mr.I”, and requesting the distribution of the distributing information of “distributing document No.:1000”.

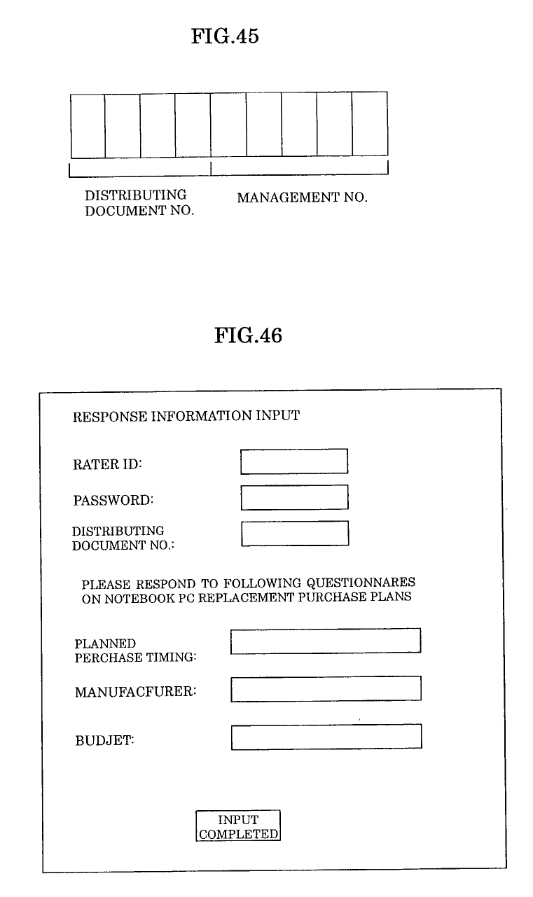

The information provider 12 issues distributing document codes for the number of the specific raters by the received information distribution request M78. In this case, the format of the distributing document code is composed of 4 digits of the distributing document number and 5 digits of management number as shown in FIG. 45. At this time, for 3 specific raters, management numbers “00001”, “00002”, and “00003” are issued. These management numbers are combined with the above-mentioned distributing document number to issue the distributing document codes “distributing document code 100000001”, “distributing document code 100000002”, and “distributing document code=100000003”.

Then, the information provider 12 transmits a rater communication information request M79 for obtaining the communication information on the network for “Mr.G” that is the specific rater to the rater information manager 2. The rater information manager 2 obtains “GGG” as an E-mail address that is the communication information on the network for “Mr.G” by referring to the rater authentication file shown in FIG. 35, and transmits a rater communication information response M80 to the information provider 12.

The information provider 12 transmits the distributing information M77 addressed to “Mr.G” based on the received rater communication information response M80 through the I/O portion 1.

Similarly, the processing of portion \hat{2} surrounded by a dotted line in FIG. 44 is repeated for “Mr.H” and “Mr.I”.

It is to be noted that by the E-mails addressed to “Mr.G”, “Mr.H” and “Mr.I”, “distributing document code=100000001”, “distributing document code=100000002”, and “distributing document code=100000003” are respectively distributed together with the distributing information M77.

(7-3) Collection of response information for the distributing information

Hereinafter, an operation of the server 100 at the time when the company “A” collects the response information for the distributing information will be described. In this case, “Mr.G”, “Mr.H”, and “Mr.I” are supposed to answer to the above-mentioned “notebook PC replacement plan questionnaire”, and company “A” is assumed to have preliminarily requested the server 100 to notify the result one week after the distribution of the distributing information.

When “Mr.G”, “Mr.H”, and “Mr.I” receive the above-mentioned distributing information by the E-mails, the screen as specifically shown in FIG. 41 is displayed. Therefore, when the indicated URL (Unified Resource Locator) is clicked, a response information input screen as shown in FIG. 46 is displayed.

For example, a case is assumed where “Mr.G” inputs the following response information according to the input format of the screen:

“Rater ID=B0001”

“Password=8673”

“Distributing document code=100000001”

“Purchase schedule=within 1 month”

“Manufacturer=company “A”

“Budget=200000 Yen or less”

When “Mr.G” presses the “input completed” button on the screen after inputting the above-mentioned response information, the above-mentioned response information is transmitted to the server 100.

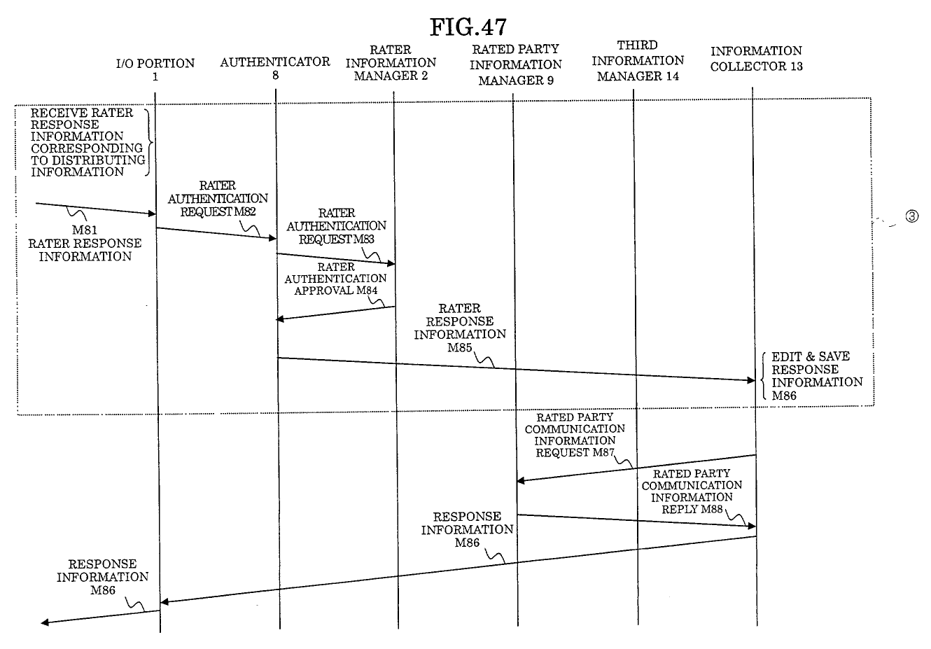

The processing of the server 100 in this case will be described referring to FIGS. 43 and 47. It is to be noted that FIG. 47 shows an operation sequence of FIG. 43 related to the reception of the response information.

The I/O portion 1 receives the above-mentioned response information as response information M81, and sets the received contents in a rater authentication request M82 to be transmitted to the authenticator 8.

In order to perform an authentication of “Mr.G”, the authenticator 8 edits a rater authentication request M83 in which “Rater ID=B0001”, and “Password=8673” are set to be transmitted to the rater information manager 2.

The rater information manager 2 retrieves the rater authentication file (see FIG. 35) in the database DB, and in case of the registered rater, returns a rater authentication approval M84 to the authenticator 8.

It is to be noted that while in this embodiment (7), the authentication of the rater inputting the response information is performed as mentioned above, the rater ID and the password may be left un-inputted and the response information may be accepted without performing the authentication.

The authenticator 8 successively transmits a rater response information M85 in which the “Distributing document code=100000001” and questionnaire response information “Purchase schedule=within 1 month”, “Manufacturer=company A”, and “Budget=200000 Yen or less” to the information collector 13.

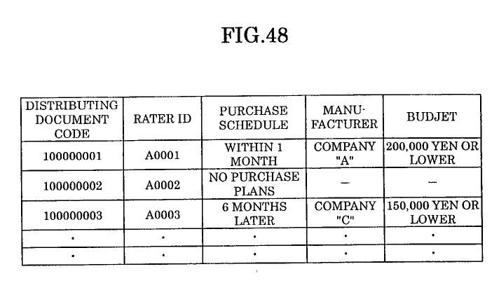

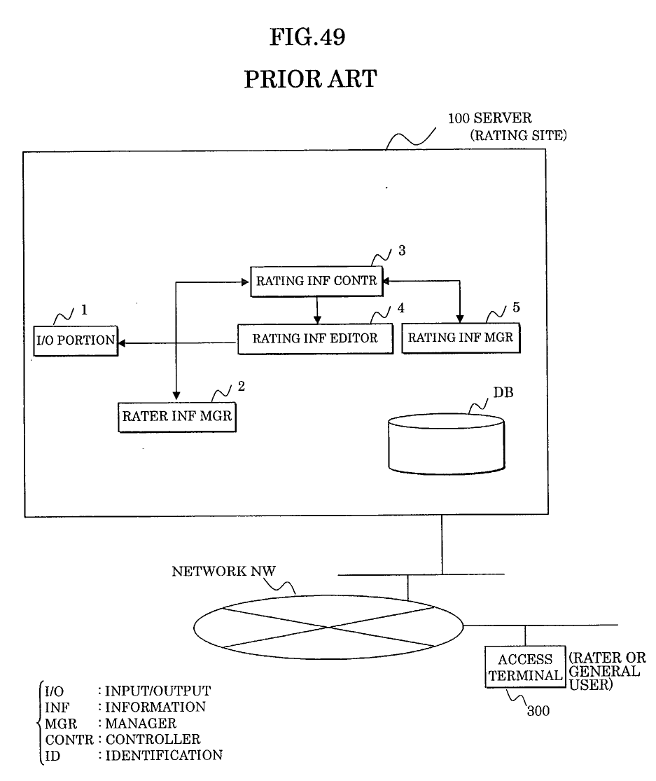

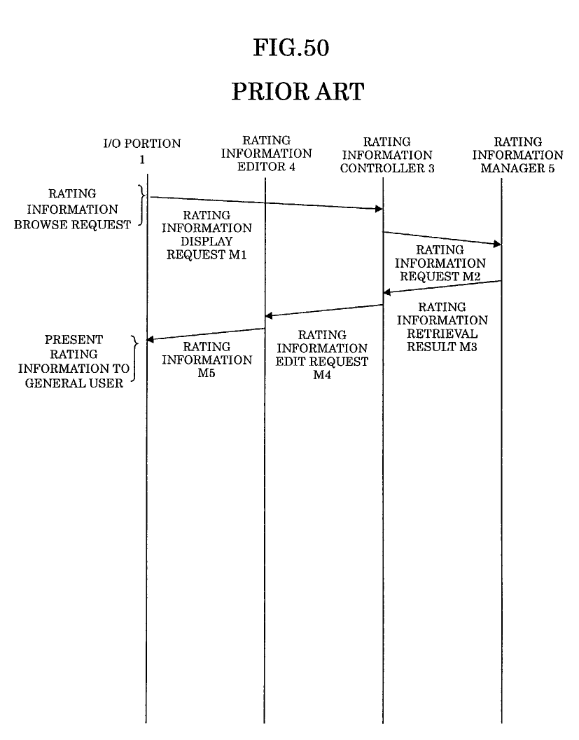

The information collector 13 accumulates the rater response information M85 in a response data file for questionnaire on notebook PC replacement purchase plans (see FIG. 48) in the database DB as the response information M86.

As for “Mr.H” and “Mr.I”, in the same way as mentioned above, the processing of portion \hat{3} surrounded by a dotted line in FIG. 47 is repeated. As a result, the response information is accumulated for the “distributing document code” of “100000001”-“100000003” as shown in FIG. 48.

Thereafter, when the term of “one week after the distribution of the distributing information” preliminarily designated by the company “A” expires, the information collector 13 transmits a rated party communication information request M87 for obtaining the communication information on the network of the company “A” that is the requestor to the rated party information manager 9.

The rated party information manager 9 retrieves the company code determination file (see FIG. 36) in the database DB, extracts an E-mail address “AAA” that is the communication information on the network of the company “A”, and responds to the information collector 13 with a rated party communication information response M88.

The information collector 13 transmits response information M86 as a collection result of the “questionnaire on notebook PC replacement purchase plans” addressed to the mail address “AAA” of the company “A” based on the received rated party communication information response M88.

The I/O portion 1 distributes the response information M86 to the company “A” by an E-mail function.

While this embodiment (7) deals with a case where the requestor who requests the extraction of the specific raters, the distribution of the distributing information to the specific rater, and the collection of the response information for the distributing information is the rated party, the requester only need be preliminarily registered in the server 100, and may be a rater or a third party.

In this case, like the above-mentioned embodiment (3), the authentication of the requester may be performed by using the rater information manager 2 or the third party information manager 14 instead of the rated party information manager 9. Also, the information collector 13 has only to inquire the rater information manager 2 or the third party information manager 14, respectively when obtaining the communication information of the requestor.

While in the above description, the components of the server 100 have been described as individual components by the function, an arrangement for reducing the frequency of inquiry to the rater information manager 2, for example, by incorporating the function of the information provider 12 in the specific rater extractor 11 is possible.

Also, while in this embodiment (7), it is required that the rater preliminarily agrees that a couple of the rater information and the rating information is secondarily used and that there is a possibility of the distribution of the distributing information, a rater point may be provided as an incentive of the agreement, in the same way as the above-mentioned embodiment (6). Moreover, a rater point for the response information input may be provided.

While in the description of the above-mentioned embodiments (1)-(7), the PC is used as an access terminal, the access terminal in the present invention is not limited to the PC, but may be an apparatus connectable to the network such as a mobile phone, a fixed phone, a facsimile machine, and the like.

Also, neither the communication means is limited to the E-mail, nor the network is limited to the Internet.

As described above, a method and an apparatus for rating information management according to the present invention are arranged such that a server registers rater information inputted by a rater from the access terminal, prepares rating identification information associated with a rated item to be assigned to a rated party, who is a provider of the rated item, when the rated party requests from the access terminal to assign a rating identification information which the rated party provides to the rater at a same time when the rated item is provided to the rater, confirms that the rater has been registered in the server and that the rating identification information is correct, and stores the rating information together with the rating identification information in a database when the rater inputs the rating identification information assigned to the rated item by the rated party with rating information added thereto from the access terminal. Therefore, it is made possible to manage and present rating information of a higher reliability.

Also, when the method and the apparatus for rating information management according to the present invention are arranged such that based on the request from a requestor preliminarily registered in the server, the server extracts a specific rater corresponding to an arbitrary extracting condition for the rating information and the rater information, distributes the distributing information to the specific rater, and accumulates the response information from the specific rater to the distributing information, and thereafter notifies the accumulated response information to the requestor upon satisfaction of a result notifying condition, it is made possible to distribute information to the rater and to collect response information in reply thereto from the rater based on the highly reliable rating information.

What we claim is:

1. A rating information management method comprising:
a first step, by a rater, of registering rater information in a server from an arbitrary access terminal connected to a network;
a second step, by a rated party who is a provider of a rated item, of requesting the server from the access terminal to assign a rating identification information which the rated party provides to the rater at a same time when the rated item is provided to the rater;
a third step, by the server, in response to the second step, of preparing the rating identification information associated with the rated item to be assigned to the rated party through the access terminal;
a fourth step, by the rater, of inputting the rating identification information assigned to the rated item by the rated party with rating information added thereto to the server from the access terminal;
a fifth step, by the server, of confirming that the rater has been registered in the server and that the rating identification information is correct, and storing the rating information together with the rating identification information in a database.

2. The rating information management method as claimed in claim 1 further comprising:
a sixth step, by the rated party, of registering rated party information in the server from the access terminal prior to the second step;
the server confirming that the rated party has been registered in the server before preparing the rating identification information at the third step.

3. The rating information management method as claimed in claim 1 further comprising:
a seventh step, by an arbitrary general user, of requesting the server from the access terminal to present the rating information; and
an eighth step, by the server in response to the seventh step, of presenting the rating information to the access terminal.

4. The rating information management method as claimed in claim 2 wherein the rating identification information includes common identification information common to a plurality of rated parties further comprising:
a ninth step, by a requester preliminarily registered in the server, of requesting the server from the access terminal to analyze the rating information based on the common identification information; and
a tenth step, by the server in response to the ninth step, of confirming that the requester has been registered, and thereafter notifying a result of an analysis of the rating information based on the common identification information to the requestor through the access terminal.

5. The rating information management method as claimed in claim 4 wherein the rating identification information includes individual identification information uniquely set by an individual rated party further comprising:
an eleventh step, by the requester, of requesting the server from the access terminal to analyze the rating information based on the individual identification information; and
a twelfth step, by the server in response to the eleventh step, of confirming that the requestor has been registered, and thereafter notifying a result of an analysis of the rating information based on the individual identification information to the requestor through the access terminal.

6. The rating information management method as claimed in claim 1 further comprising:
a thirteenth step, by the server, of providing predetermined points to the rater who inputs the rating information.

7. The rating information management method as claimed in claim 1 wherein the rating identification information includes common identification information common to a plurality of rated parties further comprising:
a fourteenth step, by an arbitrary general user, of requesting the server from the access terminal to analyze the rating information based on the common identification information; and
a fifteenth step, by the server in response to the fourteenth step, of notifying a result of an analysis of the rating information based on the common identification information to the general user through the access terminal.

8. The rating information management method as claimed in claim 7 wherein the rating identification information includes individual identification information uniquely set by an individual rated party further comprising:
a sixteenth step, by the general user, of requesting the server from the access terminal to analyze the rating information based on the individual identification information; and
a seventeenth step, by the server in response to the sixteenth step, of notifying a result of an analysis of the rating information based on the individual identification information to the general user through the access terminal.

9. The rating information management method as claimed in claim 1 wherein the rated item includes a service provided by the rated party.

10. The rating information management method as claimed in claim 1 further comprising:
an eighteenth step, by a requester preliminarily registered in the server, of designating an arbitrary extracting condition for the rating information and the rater information, and requesting the server from the access terminal to extract a specific rater corresponding to the extracting condition from among the raters; and
a nineteenth step, by the server in response to the eighteenth step, of confirming that the requestor has been registered, and thereafter extracting the specific rater.

11. The rating information management method as claimed in claim 10 further comprising:
a twentieth step, by the requester, of designating arbitrary distributing information, and requesting the server from the access terminal to distribute the distributing information to the specific rater; and
a twenty-first step, by the server in response to the twentieth step, of distributing the distributing information to the specific rater through the access terminal.

12. The rating information management method as claimed in claim 11 wherein the twentieth step includes a step, by the requester, of designating a result notifying condition together with the distributing information, the method further comprising:
a twenty-second step, by the specific rater, of inputting response information for the distributing information from the access terminal to the server; and
a twenty-third step, by the server in response to the twenty-second step, of accumulating the response information, and thereafter upon the result notifying condition being fulfilled, of notifying the accumulated response information to the requestor through the access terminal.

13. The rating information management method as claimed in claim 4 further comprising a twenty-fourth step, by a third party, when the requestor comprises the third party corresponding to neither the rated party nor the rater, of registering third party information to the server from the access terminal.

14. A rating information management apparatus comprising:
an arbitrary access terminal connected to a network; and
a server including first means for registering rater information inputted by a rater from the access terminal, second means for preparing rating identification information associated with a rated item to be assigned to a rated party, who is a provider of the rated item, through the access terminal when requested by the rated party from the access terminal to assign a rating identification information which the rated party provides to the rater at a same time when the rated item is provided to the rater, and third means for confirming that the rater has been registered in the server and that the rating identification information is correct, and storing the rating information together with the rating identification information in a database when the rater inputs the rating identification information assigned to the rated item by the rated party with rating information added thereto from the access terminal.

15. The rating information management apparatus as claimed in claim 14 wherein the server further includes fourth means for registering rated party information inputted by the rated party from the access terminal, and the second means include means for confirming that the rated party has been registered before preparing the rating identification information.

16. The rating information management apparatus as claimed in claim 14 wherein the server further includes fifth means for presenting the rating information to the access terminal when requested by an arbitrary general user from the access terminal to present the rating information.

17. The rating information management apparatus as claimed in claim 15 wherein the rating identification information includes common identification information common to a plurality of rated parties, and the server further includes sixth means confirming that a requestor preliminarily registered in the server has been registered, and thereafter notifying a result of an analysis of the rating information based on the common identification information to the requestor through the access terminal when requested by the requestor from the access terminal to analyze the rating information based on the common identification information.

18. The rating information management apparatus as claimed in claim 17 wherein the rating identification information includes individual identification information uniquely set by an individual rated party, and the server further includes seventh means for confirming that the requester has been registered, and thereafter notifying a result of an analysis of the rating information based on the individual identification information to the requester through the access terminal when requested by the requestor from the access terminal to analyze the rating information based on the individual identification information.

19. The rating information management apparatus as claimed in claim 14 wherein the server further includes eighth means for providing predetermined points to the rater who inputs the rating information.

20. The rating information management apparatus as claimed in claim 14 wherein the rating identification information includes common identification information common to a plurality of rated parties wherein the server further includes ninth means for notifying a result of an analysis of the rating information based on the common identification information to the general user through the access terminal when requested by an arbitrary general user from the access terminal to analyze the rating information based on the common identification information.

21. The rating information management apparatus as claimed in claim 20 wherein the rating identification information includes individual identification information uniquely set by an individual rated party wherein the server further includes tenth means for notifying a result of an analysis of the rating information based on the individual identification information to the general user through the access terminal when requested by the general user from the access terminal to analyze the rating information based on the individual identification information.

22. The rating information management apparatus as claimed in claim 14 wherein the rated item includes a service provided by the rated party.

23. The rating information management apparatus as claimed in claim 14 wherein the server further includes eleventh means for confirming, when a requestor preliminarily registered in the server designates an arbitrary extracting condition for the rating information and the rater information and requests the server from the access terminal to extract a specific rater corresponding to the extracting condition from among the raters, that the requester has been already registered, and thereafter extracting the specific rater.

24. The rating information management apparatus as claimed in claim 23 wherein the server further includes twelfth means for distributing, when the requester designates arbitrary distributing information and requests the server from the access terminal to distribute the distributing information to the specific rater, the distributing information to the specific rater through the access terminal.

25. The rating information management apparatus as claimed in claim 24 wherein the requester designates a result notifying condition together with the distributing information, and the server further includes thirteenth means for authenticating the specific rater when the specific rater inputs response information for the distributing information from the access terminal to the server, and thereafter accumulating the response information and notifying the requestor of the accumulated response information through the access terminal upon satisfaction of the result notifying condition.

26. The rating information management apparatus as claimed in claim 17 wherein the server further includes fourteenth means for registering, when the requester is a third party corresponding to neither the rated party nor the rater, in the server third party information inputted by the third party from the access terminal.

27. The rating information management method as claimed in claim 10 further comprising a twenty-fourth step, by a third party, when the requester comprises the third party corresponding to neither the rated party nor the rater, of registering third party information to the server from the access terminal.

28. The rating information management apparatus as claimed in claim 23 wherein the server further includes fourteenth means for registering, when the requester is a third party corresponding to neither the rated party nor the rater, in the server third party information inputted by the third party from the access terminal.
